(19) United States
(12) Patent Application Publication
(10) Pub. No.: US 2008/0318087 A1
(43) Pub. Date: Dec. 25, 2008

(54) MAGNETIC RECORDING MEDIUM, AND METHOD OF MANUFACTURE THEREOF

(75) Inventors: Yasushi HATTORI, Odawara-shi (JP); Koichi Kawamura, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/139,038

(22) Filed: Jun. 13, 2008

(30) Foreign Application Priority Data
Jun. 19, 2007 (JP) 2007-161796

(51) Int. Cl. G11B 5/62; B05D 5/12

(52) U.S. Cl. 428/840; 427/131

(57) ABSTRACT

Provided is a magnetic recording medium which causes a reduction of transition noises and has a high productivity, and a method of manufacture thereof. The method of manufacturing a magnetic recording medium, comprising:
fixing a polymerization initiator on a support by microcontact printing,
forming a grafted polymer pattern by bringing a compound having a polymerizable unsaturated bond into contact with the polymerization initiator fixed on the support followed by graft polymerization of the compound, and
forming a magnetic region by coating, onto the pattern, an alloy-particle-containing liquid which contains alloy particles capable of forming a CuAu pattern or Cu₃Au pattern ferromagnetic ordered alloy, and further subjecting the resultant to annealing processing, thereby forming a plurality of magnetic regions physically independent of each other.

### CROSS-REFERENCE TO RELATED APPLICATION

This application claims priority under 35USC119 from Japanese Patent Application No. 2007-161796, the disclosures of which are incorporated by reference herein.

### BACKGROUND OF THE INVENTION

1. Field of the Invention

The present invention relates to a magnetic recording medium, and a method of manufacture thereof.

2. Description of the Related Art

About magnetic recording media, the recording density thereof has been made higher by making the size of magnetic bodies thereof smaller. However, when the magnetic bodies are made smaller, there is a danger that the magnetic bodies become non-ferromagnetic bodies due to thermal fluctuation. Moreover, with an increase in the recording density, a problem of transition noise generation occurs.

As a method for restraining the thermal fluctuation, suggested is a method using CuAu pattern ferromagnetic ordered alloy or Cu₃Au pattern ferromagnetic ordered alloy.

As a promising countermeasure against transition noise, the use of patterned media is suggested. Firstly, as one of the patterned media, an embodiment wherein a pattern made of magnetic bodies are formed as protrusions on a support is suggested. However, according to this embodiment, the projections formed on the substrate surface cause problems when a flying head is run thereon.

Also disclosed is a method of forming a magnetic thin layer in grooved trenches formed on a substrate (see, for example, JP-A No. 2001-110050). In this method, the patterned media is prepared by (1) a substrate being covered with a mask pattern, (2) grooved trenches being formed in the substrate by etching processing, and then (3) a magnetic thin layer being formed in the grooved trenches by sputtering or the like, and (4) removing the mask pattern. Such a surface may be considered superior from the perspective of smoothness.

However, in the method forming the magnetic thin layer in the grooved trenches formed in the substrate, the mask pattern makes projections relative to the substrate, and when the magnetic thin layer is formed by sputtering the magnetic thin layer is preferentially formed on the projecting areas. The magnetic thin layer formed on the projected portions is removed along with the removal of the mask pattern, and so this is disadvantageous in terms of productivity.

In the processing of a mask pattern by use of a stepper, the precision of the processing is high in an area where exposure to light is attained in a single exposure operation; however, for example, when a pattern is formed on the entire surface of a 2.5 inch disc, problems arise of positional precision of the patterns. In other words, when a pattern is formed on the entire surface of a 2.5 inch disc, it is necessary to perform operation of exposure to light several times, using different original plates. Thus, misalignment of the boundaries of the sub-patterns generated in the individual exposure operations occur.

Furthermore, a stepper is an expensive machine. Thus, whereas it is economic to use a stepper when a great number of products are produced from an area where a single exposure operation is carried out, as with semiconductor devices, however, for patterned media, plural exposure operations are required for each product thereof, which is not economic.

### SUMMARY OF THE INVENTION

The present invention has been made in view of the above circumstances and provides a magnetic recording medium, and a method of manufacture thereof.

A first aspect of the present invention provides a method of manufacturing a magnetic recording medium, comprising:

a polymerization initiator fixing step of fixing a polymerization initiator on a support by microcontact printing, a grafted polymer pattern forming step of bringing a compound having a polymerizable unsaturated bond into contact with the polymerization initiator fixed on the support followed by graft polymerization of the compound, and a magnetic region forming step of coating, onto the pattern, an alloy-particle-containing liquid which contains alloy particles capable of forming a CuAu pattern or Cu₃Au pattern ferromagnetic ordered alloy, and further subjecting the resultant to annealing processing, thereby forming magnetic regions physically independent of each other.

A second aspect of the present invention provides a magnetic recording medium produced by the method of manufacturing according to the first aspect above.

### BRIEF DESCRIPTION OF THE DRAWINGS

Exemplary embodiments of the present invention will be described in detail based on the following figures, wherein:

FIG. 1 is a plan view illustrating a portion of an example of the magnetic recording medium of the invention.

### DETAILED DESCRIPTION OF THE INVENTION

An object of the invention is to solve the above-mentioned problems in the prior art. Specifically, an object of the invention is to provide a magnetic recording medium which causes a reduction of transition noises and has a high productivity, and a method of manufacture thereof.

In light of the above-mentioned situation, the inventors have made eager researches to find out that the above-mentioned problems may be solved. Thus, the invention has been made.

Accordingly, the invention attains the object by aspects and embodiments of the following items <1> to <5>:
<1>. A method of manufacturing a magnetic recording medium, comprising:

fixing a polymerization initiator on a support by microcontact printing, forming a grafted polymer pattern by bringing a compound having a polymerizable unsaturated bond into contact with the polymerization initiator fixed on the support followed by graft polymerization of the compound, and forming a magnetic region by coating, onto the pattern, an alloy-particle-containing liquid which contains alloy particles capable of forming a CuAu pattern or Cu₃Au pattern ferromagnetic ordered alloy, and further subjecting the resultant to annealing processing, thereby forming a plurality of magnetic regions physically independent of each other.
<2>. The method of manufacturing item <1> above, further comprising polishing the surface of the support, which has the formed magnetic regions thereon.
<3>. The method of manufacturing item <1>or <2> above, further comprising oxidizing treatment.
<4>. The method of manufacturing any one of items <1> to <3> above, further comprising forming a protective layer.
<5>. A magnetic recording medium produced by the method of manufacturing any one of items <1> to <4> above.

<Method of Manufacturing a Magnetic Recording Medium>

The method of manufacturing a magnetic recording medium of the invention includes: a polymerization initiator fixing step of fixing a polymerization initiator on a support by microcontact printing; a grafted polymer pattern forming step of bringing a compound having a polymerizable unsaturated bond into contact with the polymerization initiator fixed on the support followed by graft polymerization of the compound; and a magnetic region forming step of coating, onto the pattern, an alloy-particle-containing liquid which contains alloy particles capable of forming a CuAu pattern or Cu₃Au pattern ferromagnetic ordered alloy, and further subjecting the resultant to annealing processing, thereby forming magnetic regions physically independent of each other.

In the formation of the magnetic regions, the alloy-particle-containing liquid may be coated onto not only convex portions made of the graft polymer but also concave portions made thereof. In such a case, polishing is conducted if necessary. The magnetic recording medium produced by this process is preferably subjected to oxidizing treatment, such as heating treatment in the air. Furthermore, it is preferred to embed a nonmagnetic substance between the magnetic regions, or form a protective layer or a lubricant layer in the medium.

The following will describe each of the steps in detail.

—Polymerization Initiator Fixing Step—

In the polymerization initiator fixing step, a polymerization initiator is fixed on a support by microcontact printing.

The microcontact printing is one of nano-structure constructing methods reported by G. M. Whitesides et al., in 1993, which are collectively called soft lithography. A shape pattern (stamp) of a nano-scale or micrometer-scale structure is produced by photolithography or electron beam lithography, which is a conventional method. The pattern is transcribed on a rubbery plastic. The microcontact printing is a process of coating molecules onto the convex surface of this stamp, and bringing the resultant into close contact with a support, thereby forming a patterned molecule membrane on the support. By use of this stamp, a micro-pattern may easily be copied at low costs.

At this time, by use of chemical reaction between the molecules and the support surface, a stable membrane (self assembled monolayer: SAM) having a monomolecular thickness may be formed into a pattern on the support. Examples of a combination of the molecules and the surface include a combination of thiol molecules and a surface of gold (S atoms-Au); and a combination of silane molecules and a surface of an oxide, that is, an insulator having OH-groups (Si atoms-O—).

The technique is described in detail in Xia, Y.; Whitesides, G. M. Angew. Chem., Int. Ed. Engl. 1998, 37, 550-575.

Specifically, as the material of the stamp, a silicon rubber such as polydimethylsiloxane (PDMS) is used. The method for forming the stamp is, for example, a method of forming a mold wherein a convex and concave pattern is beforehand formed in such a manner that desired patterned image regions will be convex regions of the stamp, casting heated and melted PDMS into the mold to render the convex regions the desired patterned image regions, cooling the PDMS so as to be cured, and then peeling off the PDMS. In such a way, an uneven stamp that is imagewise patterned is produced.

Next, to the stamp is applied a solution of molecules for producing an SAM, for example, a solution of a thiol-terminated polymerization initiator, a chlorosilane-terminated polymerization initiator or an alkoxysilane-terminated polymerization initiator. Alternatively, the stamp is immersed into the solution. In this way, the polymerization initiator attached to the convex regions of the stamp is caused to adhere closely to a support, thereby forming (or fixing) a polymerization initiator layer into the form of a patterned image on the support.

(Support)

The support in the invention may be any inorganic support or organic support as long as the support is a support that may be used in magnetic recording media. The support is appropriately selected in accordance with the kind of the polymerization initiator, or the usage of the medium.

Examples of the material for the inorganic support include Al, Mg alloys such as Al—Mg alloy and Mg—Al—Zn alloy, glass, quartz, carbon, silicon, and ceramics. The support made of each of these materials is excellent in impact resistance and has a rigidity suitable for making the support thin or rotating the support at a high velocity. Moreover, the support is characterized by having a higher resistance against heat than organic supports.

Examples of materials for organic supports include polyesters such as polyethylene terephthalate or polyethylene naphthalate, polyolefins, cellulose triacetate, polycarbonates, polyamides (including aliphatic polyamides and aromatic polyamides such as aramid), polyimides, polyamideimides, polysulfones, or polybenzoxazole.

(Polymerization Initiator)

The polymerization initiator used for the micro contact printing can preferably be, for example, (a) an aromatic ketone, (b) an onium salt, (c) an organic peroxide, (d) a thio compound, (e) a hexaarylbiimidazole compound, (f) a ketoxime ester, (g) a borate compound, (h) an azinium compound, (i) an active ester compound, (j) a compound having a carbon-halogen bond, or (k) a pyridinium compound. Specific examples of (a) to (k) are shown in the following, but the present invention is not limited by such examples.

(a) Aromatic Ketones

In the invention, preferred examples of (a) aromatic ketone as a polymerization initiator include the compounds each having a benzophenone skeleton or a thioxanthone skeleton disclosed in J. P. Fouassier and J. F. Rabek, RADIATION CURING IN POLYMER SCIENCE AND TECHNOLOGY, pp. 77-117, 1993, (the disclosure of which is incorporated herein by reference), such as the following compounds:

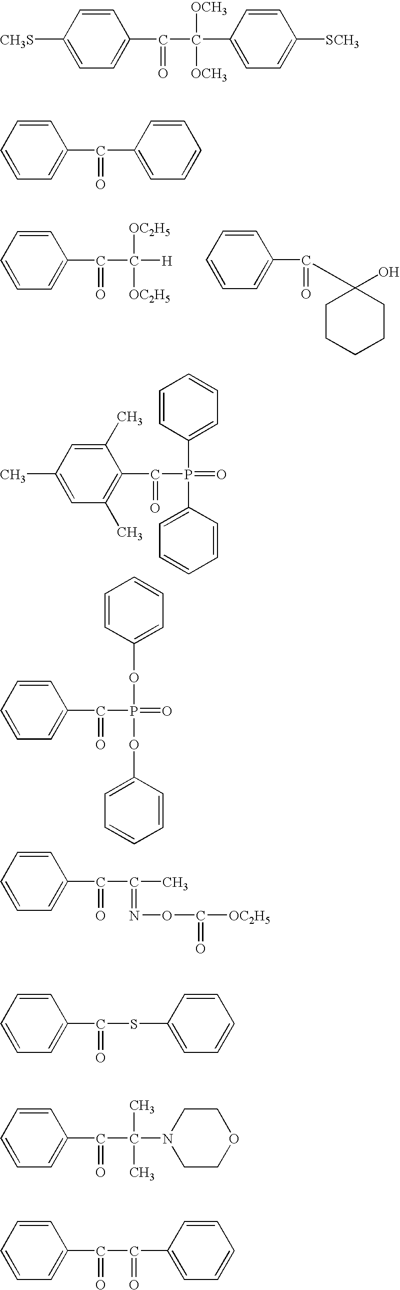

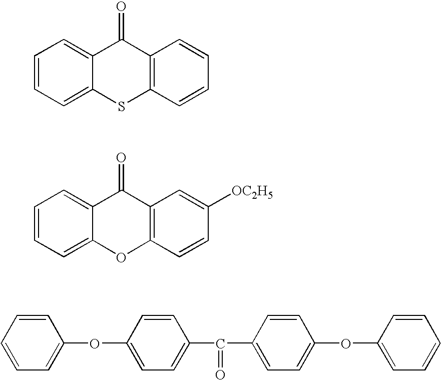

Among them, preferable examples of (a) the aromatic ketones are listed below. Examples of the aromatic ketones include an alpha-thiobenzophenone compound described in Japanese Patent Application publication (JP-B) No. 47-6416, and a benzoin ether compound described in Japanese Patent Application publication (JP-B) No. 47-3981, for example, the following compound.

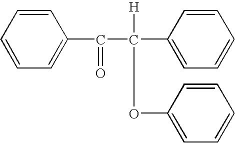

Examples of the aromatic ketones include an alpha-substituted benzoin compound described in Japanese Patent Application publication (JP-B) No. 47-22326, for example, the following compound.

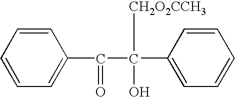

Examples of the aromatic ketones include a benzoin derivative described in Japanese Patent Application publication (JP-B) No. 47-23664, aroylphosphonic acid ester described in Japanese Patent Application Laid-Open (JP-A) No. 57-30704, and dialkoxybenzophenone described in Japanese Patent Application publication (JP-B) No. 60-26483, for example, the following compound.

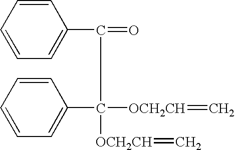

Examples of the aromatic ketones include benzoin ethers described in Japanese Patent Application publication (JP-B) No. 60-26403 and Japanese Patent Application Laid-Open (JP-A) No. 62-81345, for example, the following compound.

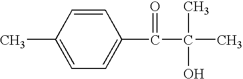

Examples of the aromatic ketones include alpha-aminobenzophenones described in Japanese Patent Application publication (JP-B) No. 1-34242, U.S. Pat. No. 4,318,791, and European Patent Application 0,284,561 A1, for example, the following compound.

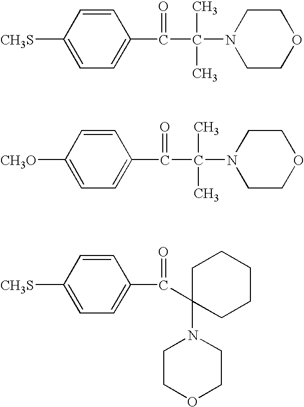

Examples of the aromatic ketones include p-di(dimethylaminobenzoyl)benzene described in Japanese Patent Application Laid-Open (JP-A) No. 2-211452, for example, the following compound.

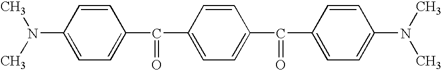

Examples of the aromatic ketones include thio-substituted aromatic ketone described in Japanese Patent Application Laid-Open (JP-A) No. 61-194062, for example, the following compound.

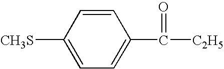

Examples of the aromatic ketones include acylphosphine sulfide described in Japanese Patent Application publication (JP-B) No. 2-9597, for example, the following compound.

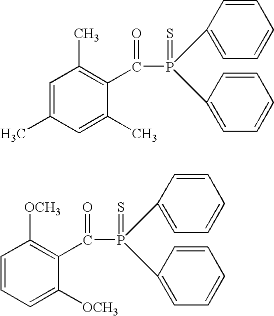

Examples of the aromatic ketones include acylphosphine described in Japanese Patent Application publication (JP-B) No. 2-9596, for example, the following compound.

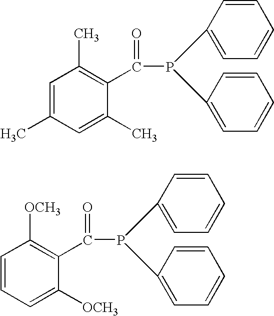

Examples of the aromatic ketones include thioxanthones described in Japanese Patent Application publication (JP-B) No. 63-61950 and coumarins described in Japanese Patent Application publication (JP-B) No. 59-42864.

(b) Onium Salt Compound

In the invention, preferred examples of (b) onium salt compound as a polymerization initiator can be compounds represented by following general formula (1) to (3):

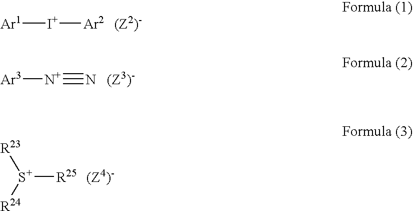

In the formula (1), Ar¹ and Ar² each independently represents an aryl group having 20 or less carbon atoms which may have a substitutent. In case the aryl group has a substituent, preferred examples of the substituent include a halogen atom, a nitro group, an alkyl group having 12 or less carbon atoms, an alkoxy group having 12 or less carbon atoms, and an aryloxy group having 12 or less carbon atoms. (Z²)⁻ represents a counter ion selected from a group of a halogen ion, a perchlorate ion, a carboxylate ion, a tetrafluoroborate ion, a hexafluorophosphate ion, and a sulfonate ion, and is preferably a perchlorate ion, a hexafluorophosphate ion, or an arylsulfonate ion.

In the formula (2), Ar³ represents an aryl group having 20 or less carbon atoms, which may have substituent(s). Preferred examples of the substituent include a halogen atom, a nitro group, an alkyl group having 12 or less carbon atoms, an alkoxy group having 12 or less carbon atoms, an aryloxy group having 12 or less carbon atoms, an alkylamino group having 12 or less carbon atoms, a dialkylamino group having 12 or less carbon atoms, an arylamino group having 12 or less carbon atoms, and a diarylamino group having 12 or less carbon atoms. (Z³)⁻ represents a counter ion of a same definition as (Z²)⁻ in the general formula (1).

In the formula (3), R²³, R²⁴ and R²⁵, which may be same or different, each independently represents a hydrocarbon group having 20 or less carbon atoms, which may have substituent(s). Preferred examples of the substituent include a halogen atom, a nitro group, an alkyl group having 12 or less carbon atoms, an alkoxy group having 12 or less carbon atoms, and an aryloxy group having 12 or less carbon atoms. (Z⁴)⁻ represents a counter ion of a same definition as (Z²)⁻ in the general formula (1).

Specific examples of the onium salt advantageously employable in the invention are described in Japanese Patent Application Laid-Open (JP-A) No. 2001-133969, paragraphs [0030] to [0033], Japanese Patent Application Laid-Open (JP-A) No. 2001-305734, paragraphs [0048] to [0052] and Japanese Patent Application Laid-Open (JP-A) No. 2001-343742, paragraphs [0015] to [0046].

(c) Organic Peroxide Compound

In the invention, preferred examples of (c) organic peroxide compound as a polymerization initiator include almost all compounds having one or more oxygen-oxygen bond in a molecule. Examples of the organic peroxide compounds include methyl ethyl ketone peroxide, cyclohexane peroxide, 3,3,5-trimethylcyclohexanone peroxide, methylcyclohexanone peroxide, acetylacetone peroxide, 1,1-bis(tert-butylperoxy)-3,3,5-trimethylcyclohexane, 1,1-bis(tert-butylperoxy)cyclohexane, 2,2-bis(tert-butylperoxy)butane, tert-butyl hydroperoxide, cumene hydroperoxide, diisopropylbenzene hydroperoxide, paramethane hydroperoxide, 2,5-dimethylhexane-2,5-dihydroperoxide, 1,1,3,3-tetramethylbutyl hydroperoxide, di(tert-butyl)hydroperoxide, tert-butylcumyl peroxide, dicumyl peroxide, bis(tert-butylperoxy-iso-propyl)benzene, 2,5-dimethyl-2,5-di(tert-butylperoxy)hexane, 2,5-oxanoyl peroxide, succinyl peroxide, benzoyl peroxide, 2,4-dichlorobenzoyl peroxide, meta-toluoyl peroxide, diisopropyl peroxydicarbonate, di-2-ethylhexyl peroxydicarbonate, di-2-ethoxyethyl peroxydicarbonate, dimethoxyisopropyl peroxycarbonate, di(3-methyl-3-methoxybutyl)peroxydicarbonate, tert-butyl peroxyacetate, tert-butyl peroxypivalate, tert-butyl peroxyneodecanoate, tert-butyl peroxyoctanoate, tert-butyl peroxyl-3,5,5-trimethyl hexanoate, tert-butyl peroxylaurate, tosyl carbonate, 3,3′,4,4′-tetra-(t-butylperoxycarbonyl)benzophenone, 3,3′,4,4′-tetra-(t-amylperoxycarbonyl)benzophenone, 3,3′,4,4′-tetra-(t-hexylperoxycarbonyl)benzophenone, 3,3′,4,4′-tetra-(t-octylperoxycarbonyl)benzophenone, 3,3′,4,4′-tetra-(t-cumylperoxycarbonyl)benzophenone, 3,3′,4,4′-tetra-(p-isopropylcumylperoxycarbonyl)benzophenone, carbonyl di(t-butylperoxy dihydrogen diphthalate), carbonyl di(t-hexylperoxy dihydrogen diphthalate), di(t-butyldiperoxy isophthalate) and the like.

Among these peroxide compounds, peroxyester compounds such as 3,3′,4,4′-tetra-(t-butylperoxycarbonyl)benzophenone, 3,3′,4,4′-tetra-(t-amylperoxycarbonyl)benzophenone, 3,3′,4,4′-tetra-(t-hexylperoxycarbonyl)benzophenone, 3,3′,4,4′-tetra-(t-octylperoxycarbonyl)benzophenone, 3,3′,4,4′-tetra-(t-cumylperoxycarbonyl)benzophenone, 3,3′,4,4′-tetra-(p-isopropylcumylperoxycarbonyl)benzophenone, di(t-butyldiperoxy isophthalate) are preferably used.

(d) Thio Compounds

In the invention, preferred examples of (d) thio compounds as polymerization initiators include compounds represented by Formula (4):

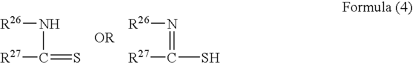

In formula (4), R²⁶ represents a hydrogen atom, an alkyl group, an aryl group or a substituted aryl groups; R²⁷ represents a hydrogen atom or an alkyl groups; or R²⁶ and R²⁷ represent such nonmetallic atomic groups that R²⁶ and R²⁷ are bonded to each other to form a five- to seven-membered ring optionally containing a hetero atom selected from oxygen atoms, sulfur atoms and nitrogen atoms.

In formula (4), when any of R²⁶ and R²⁷ represents an alkyl group, the alkyl group preferably has 1 to 4 carbon atoms. When any of R²⁶ and R²⁷ represents an aryl group, the aryl group is preferably an aryl group having 6 to 10 carbon atoms, such as a phenyl group or a naphthyl group. When any of R²⁶ and R²⁷ represents a substituted aryl group, the substituted aryl group may be an aryl group substituted by a halogen atom such as a chlorine atom, an aryl substituted by an alkyl group such as a methyl group, or an aryl group substituted by an alkoxy group such as a methoxy group or an ethoxy group. R²⁷ is preferably an alkyl group having 1 to 4 carbon atoms. Examples of the thio compound represented by formula (4) include the following compounds having substituents described in following table 1:

TABLE 1

| No. | R²⁶ | R²⁷ |
|---|---|---|
| 1 | —H | —H |
| 2 | —H | —CH₃ |
| 3 | —CH₃ | —H |
| 4 | —CH₃ | —CH₃ |
| 5 | —C₆H₅ | —C₂H₅ |
| 6 | —C₆H₅ | —C₄H₉ |
| 7 | —C₆H₄Cl | —CH₃ |
| 8 | —C₆H₄Cl | —C₄H₉ |
| 9 | —C₆H₄—CH₃ | —C₄H₉ |
| 10 | —C₆H₄—OCH₃ | —CH₃ |
| 11 | —C₆H₄—OCH₃ | —C₂H₅ |
| 12 | —C₆H₄—OC₂H₅ | —CH₃ |
| 13 | —C₆H₄—OC₂H₅ | —C₂H₅ |
| 14 | —C₆H₄—OCH₃ | —C₄H₉ |

| | |
|---|---|
| 15 | —(CH₂)₂— |
| 16 | —(CH₂)₂—S— |
| 17 | —CH(CH₃)—CH₂—S— |
| 18 | —CH₂—CH(CH₃)—S— |
| 19 | —C(CH₃)₂—CH₂—S— |
| 20 | —CH₂—C(CH₃)₂—S— |
| 21 | —(CH₂)₂—O— |
| 22 | —CH(CH₃)—CH₂—O— |
| 23 | —C(CH₃)₂—CH_{2—O—} |
| 24 | —CH═CH—N(CH₃)— |
| 25 | —(CH₂)₃—S— |
| 26 | —(CH₂)₂—CH(CH₃)—S— |
| 27 | —(CH₂)₃—O— |
| 28 | —(CH₂)₅— |
| 29 | —C₆H₄—O— |
| 30 | —N═C(SCH₃)—S— |
| 31 | —C₆H₄—NH— |
| 32 | 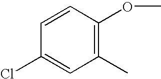 |

(e) Hexaarylbiimidazole Compounds

In the invention, examples of (e) hexaarylbiimidazole compounds as polymerization initiators include lophine dimers disclosed in JP-B Nos. 45-37377 and 44-86516 (the disclosures of which are incorporated herein by reference), such as 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(o,p-dichlorophenyl)-4,4′,5,5′-tetraphenylbiimidazole, 2,2′-bis(o-chlorophenyl)-4,4′,5,5′-tetra(m-methoxyphenyl)biimidazole, 2,2′-bis(o,o′-dichlorophenyl)-4,4′,5,5′-tetraphenylbiimidazole, 2,2′-bis(o-nitrophenyl)-4,4′,5,5′-tetraphenylbiimidazole, 2,2′-bis(o-methylphenyl)-4,4′,5,5═-tetraphenylbiimidazole, and 2,2′-bis(o-trifluorophenyl)-4,4′,5,5′-tetraphenylbiimidazole.

(f) Ketoxime Ester Compounds

In the invention, examples of (f) ketoxime ester compounds as polymerization initiators include 3-benzoyloxyiminobutan-2-one, 3-acetoxyiminobutan-2-one, 3-propionyloxyiminobutan-2-one, 2-acetoxyiminopentan-3-one, 2-acetoxyimino-1-phenylpropan-1-one, 2-benzoyloxyimino-1-phenylpropan-1-one, 3-p-toluenesulfonyloxyiminobutan-2-one, and 2-ethoxycarbonyloxyimino-1-phenylpropan-1-one.

(g) Borate Compounds

In the invention, examples of (g) borate compounds as polymerization initiators include compounds represented by formula (5):

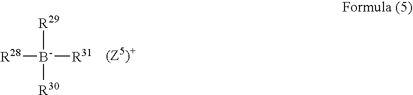

In formula (5), R²⁸, R²⁹, R³⁰, and R³¹ each independently represent a substituted or unsubstituted alkyl group, a substituted or unsubstituted aryl group, a substituted or unsubstituted alkenyl group, a substituted or unsubstituted alkynyl group, or a substituted or unsubstituted heterocyclic group; two or more of R²⁸, R²⁹, R³⁰, and R³¹ may be combined to form a ring structure; at least one of R²⁸, R²⁹, R³⁰, and R³¹ is a substituted or unsubstituted alkyl group; and (Z⁵)⁺ represents an alkali metal cation or a quaternary ammonium cation.

When any of R²⁸ to R³¹ represents an alkyl group, the alkyl may be linear, branched or cyclic and has preferably 1 to 18 carbon atoms. Examples thereof include a methyl group, an ethyl group, a propyl group, an isopropyl group, a butyl group, a pentyl group, a hexyl group, an octyl group, a stearyl group, a cyclobutyl group, a cyclopentyl group, and a cyclohexyl group. When any of R²⁸ to R³¹ represents a substituted alkyl group, the sustituted alkyl group may be an alkyl group obtained by providing any of the above alkyl groups with a substituent which may be selected from halogen atoms (such as —Cl and —Br), a cyano group, a nitro group, aryl groups (preferably a phenyl groups), a hydroxyl group, —COOR³² groups (wherein R³² represents a hydrogen atom, an alkyl having 1 to 14 carbon atoms or an aryl group), —OCOR³³ groups (wherein R³³ represents an alkyl group having 1 to 14 carbon atoms or an aryl group), —OR³⁴ groups (wherein R³⁴ represents an alkyl group having 1 to 14 carbon atoms or an aryl group), and substituents represented by the following formula:

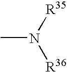

wherein R³⁵ and R³⁶ each independently represent a hydrogen atom, an alkyl group having 1 to 14 carbon atoms or an aryl group.

When any of R²⁸ to R³¹ represents an aryl group, the aryl group may be an aryl group having 1 to 3 rings such as a phenyl group and a naphthyl group. When any of R²⁸ to R³¹ represents a substituted aryl group, the substituted aryl group may be an aryl group obtained by providing such an aryl group as described above with a substituent which may be selected from: the substituents cited as examples of the substituent of the substituted alkyl group, and alkyl groups having 1 to 14 carbon atoms. The alkenyl group represented by any of R²⁸ to R³¹ may be a linear, branched or cyclic alkenyl group having 2 to 18 carbon atoms. Examples of the substituent in the substituted alkenyl group represented by any of R²⁸ to R³¹ include the substituents cited as examples of the substituent in the substituted alkyl group. The alkynyl represented by any of R²⁸ to R³¹ may be a linear or branched alkynyl group having 2 to 28 carbon atoms. Examples of the substituent in the substituted alkynyl group represented by any of R²⁸ to R³¹ include the substituents cited as examples of the substituent in the substituted alkyl group. The heterocyclic group represented by any of R²⁸ to R³¹ may be a heterocyclic group having a heterocycle comprised of five or more atoms including at least one of N, S and O, preferably a five- to seven-membered heterocyclic group containing at least one of N, S and O. Such a heterocyclic group may contain a fused ring and may have any of the above-described substituents for the substituted aryl group. Specific examples of the compound represented by formula (5) include the compounds disclosed in U.S. Pat. Nos. 3,567,453 and 4,343,891 and European Patent Nos. 109,772 and 109,773 (the disclosures of which are incorporated herein by reference) and the following compounds:

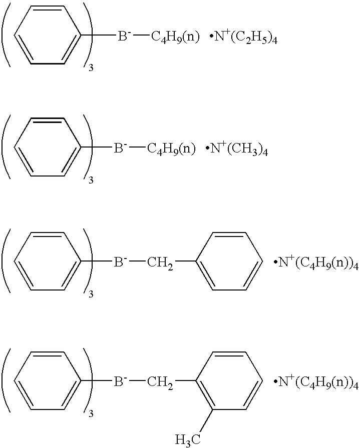

(h) Azinium Compounds

In the invention, examples of (h) azinium compounds as polymerization initiators include compounds having N—O bonds disclosed in JP-A Nos. 63-138345, 63-142345, 63-142346, and 63-143537, and JP-B No. 46-42363, the disclosures of which are incorporated herein by reference.

(i) Active Ester Compounds

In the invention, examples of (i) active ester compounds as polymerization initiators include imidosulfonate compounds disclosed in JP-B No. 62-6223 (the disclosure of which is incorporated herein by reference) and active sulfonate compounds disclosed in JP-B No. 63-14340 and JP-A No. 59-174831 (the disclosures of which are incorporated herein by reference).

(j) Compounds having Carbon-Halogen Bonds

In the invention, examples of (j) compounds having carbon-halogen bonds as polymerization initiators include compounds respectively represented by Formulae (6) to (12) below.

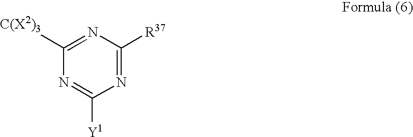

In formula (6), X² represents a halogen atom; Y¹ represents —C(X²)₃, —NH₂, —NHR³⁸, —N(R³⁸)₂, or —OR³⁸, wherein R³⁸ represents an alkyl group, a substituted alkyl group, an aryl group, or a substituted aryl group; and R³⁷ represents —C(X²)₃, an alkyl group, a substituted alkyl group, an aryl group, a substituted aryl group, or a substituted alkenyl group.

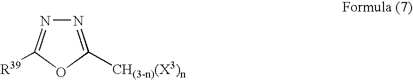

In formula (7), R³⁹ represents an alkyl group, a substituted alkyl group, an alkenyl group, a substituted alkenyl group, an aryl group, a substituted aryl group, a halogen atom, an alkoxy group, a substituted alkoxyl group, a nitro group, or a cyano group; X³ represents a halogen atom; and n represents an integer of 1 to 3.

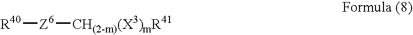

In formula (8), R⁴⁰ represents an aryl group or a substituted aryl group; R⁴¹ represents any of the groups shown below or a halogen atom; Z⁶ represents —C(═O)—, —C(═S)— or —SO₂—; X³ represents a halogen atom; and m represents an integer of 1 or 2.

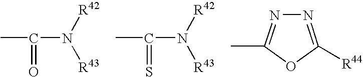

In the formulae, R⁴² and R⁴³ each independently represent an alkyl group, a substituted alkyl group, an alkenyl group, a substituted alkenyl group, an aryl group, or a substituted aryl group; and R⁴⁴ has the same definition as that of R³⁸ in formula (6).

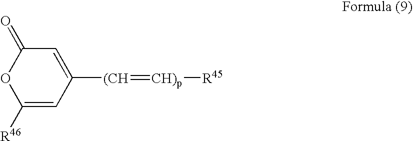

In formula (9), R⁴⁵ represents a substituted or non-substituted aryl or heterocyclic group; R⁴⁶ represents a trihaloalkyl or trihaloalkenyl group having 1 to 3 carbon atoms; and p represents 1, 2 or 3.

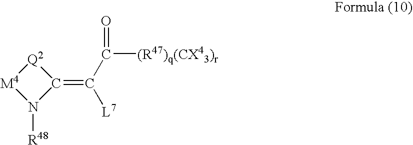

The compound represented by formula (10) is a carbonyl methylene heterocyclic compounds having a trihalogenomethyl group. In formula (10), L⁷ represents a hydrogen atom or —CO—(R⁴⁷)q(C(X⁴)₃)r; Q² represents a sulfur atom, a selenium atom, an oxygen atom, a dialkylmethylene group, an alkene-1,2-ylene group, a 1,2-phenylene group, or N—R; M⁴ represents a substituted or unsubstituted alkylene or alkenylene group, or a 1,2-arylene group; R⁴⁸ represents an alkyl group, an aralkyl group or an alkoxyalkyl group; R⁴⁷ represents a carbocyclic or heterocyclic bivalent aromatic group; X⁴ represents a chlorine atom, a bromine atom or an iodine atom; q represents 0 or 1; and r represents 1 when q represents 0 and r represents 1 or 2 when q represents 1. R represents a linear, branched or cyclic hydrocarbon group which may be saturated or unsaturated.

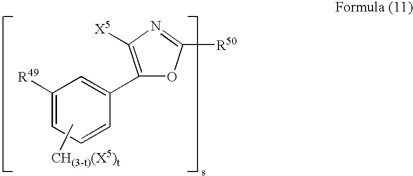

The compound represented by formula (11) represents a 4-halogeno-5-(halogenomethyl-phenyl)-oxazole derivative. In formula (11), X⁵ represents a halogen atom; t represents an integer of 1 to 3; s represents an integer of 1 to 4; R⁴⁹ represents a hydrogen atom or CH₃₋ₜX⁵ₜ; and R⁵⁰ represents a substituted or non-substituted unsaturated organic group with a valence of s.

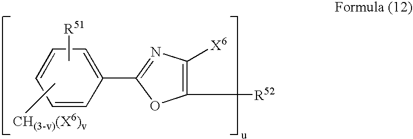

The compound represented by formula (12) is a 2-(halogenomethyl-phenyl)-4-halogeno-oxazole derivative. In formula (12), X⁶ represents a halogen atom; v represents an integer of 1 to 3; u represents an integer of 1 to 4; R⁵¹ represents a hydrogen atom or CH₃₋ᵥX⁶ᵥ; and R⁵² represents a substituted or non-substituted unsaturated organic group with a valence of u.

Specific examples of such compounds having carbon-halogen bonds include: the compounds disclosed in Wakabayashi et al., Bull. Chem. Soc. Japan, 42, 2924 (1969) (the disclosure of which is incorporated herein by reference) such as 2-phenyl-4,6-bis(trichloromethyl)-S-triazine, 2-(p-chlorophenyl)-4,6-bis(trichloromethyl)-S-triazine, 2-(p-tolyl)-4,6-bis(trichloromethyl)-S-triazine, 2-(p-methoxyphenyl)-4,6-bis(trichloromethyl)-S-triazine, 2-(2′,4′-dichlorophenyl)-4,6-bis(trichloromethyl)-S-triazine, 2,4,6-tris(trichloromethyl)-S-triazine, 2-methyl-4,6-bis(trichloromethyl)-S-triazine, 2-n-nonyl-4,6-bis(trichloromethyl)-S-triazine, and 2-(α,α,β-trichloroethyl)-4,6-bis(trichloromethyl)-S-triazine; the compounds disclosed in U.K. Patent No. 1,388,492 (the disclosure of which is incorporated herein by reference) such as 2-styryl-4,6-bis(trichloromethyl)-S-triazine, 2-(p-methylstyryl)-4,6-bis(trichloromethyl)-S-triazine, 2-(p-methoxystyryl)-4,6-bis(trichloromethyl)-S-triazine, and 2-(p-methoxystyryl)-4-amino-6-trichloromethyl-S-thriazine; the compounds disclosed in JP-A No. 53-133428 (the disclosure of which is incorporated herein by reference) such as 2-(4-methoxy-naphtho-1-yl)-4,6-bis-trichloromethyl-S-triazine, 2-(4-ethoxy-naphtho-1-yl)-4,6-bis(trichloromethyl)-S-triazine, 2-[4-(2-ethoxyethyl)-naphtho-1-yl]-4,6-bis(trichloromethyl)-S-triazine, 2-(4,7-dimethoxy-naphtho-1-yl]-4,6-bis-trichloromethyl-S-triazine, and 2-(acenaphtho-5-yl)-4,6-bis-trichloromethyl-S-triazine; and the compounds disclosed in German Patent No. 3,337,024 (the disclosure of which is incorporated herein by reference) such as the following compounds:

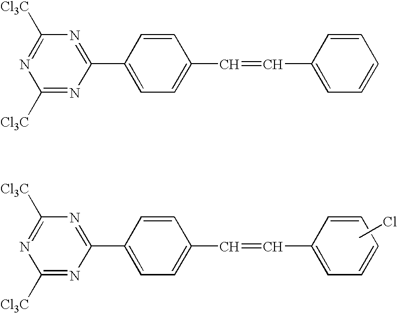

Specific examples of compounds having carbon-halogen bonds also include: the compounds disclosed in F. C. Schaefer et al., J. Org. Chem., 29, 1527 (1964) (the disclosure of which is incorporated herein by reference) such as 2-methyl-4,6-bis(tribromomethyl)-S-triazine, 2,4,6-tris(tribromomethyl)-S-triazine, 2,4,6-tris(dibromomethyl)-S-triazine, 2-amino-4-methyl-6-tribromomethyl-S-triazine, and 2-methoxy-4-methyl-6-trichloromethyl-S-triazine; and the compounds disclosed in JP-A No. 62-58241 (the disclosure of which is incorporated herein by reference) such as the following compounds:

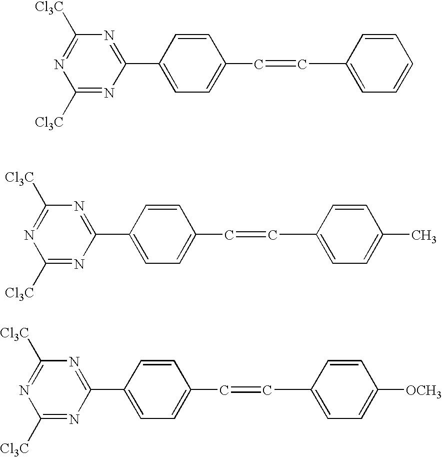

Specific examples of compounds having carbon-halogen bonds also include the compounds disclosed in JP-A No. 05-281728 such as the following compounds:

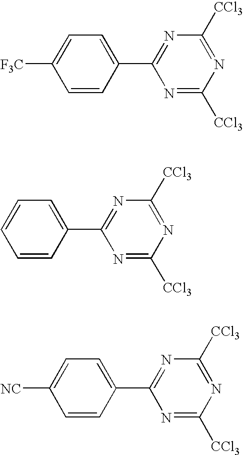

Specific examples of compounds having carbon-halogen bonds also include compounds shown below, which can be easily synthesized by one skilled in the art according to the synthesis method described in M. P. Hutt, E. F. Elslager and L. M. Herbel, Journal of Heterocyclic Chemistry, vol. 7 (No. 3), page 511 et seq. (1970), the disclosure of which is incorporated herein by reference.

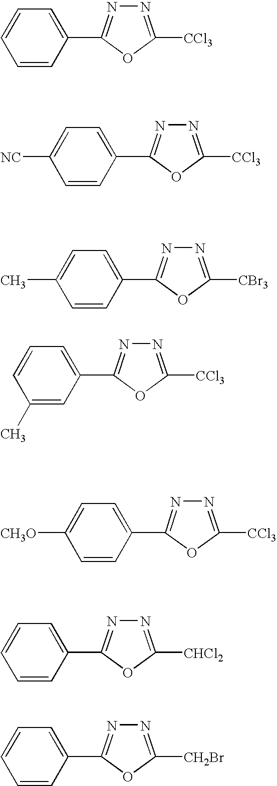

(k) Pyridinium Compounds

Preferred examples of the pyridinuim compound (k) as the polymerization initiator in the invention include pyridinium compounds described in JP-A No. 2001-305734. In particular, compounds having structures shown below are preferred.

(F type)

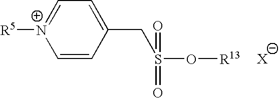

| | R⁵ | R¹³ | X |
|---|---|---|---|
| II-58 | 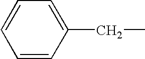 | Ph— | PF₆ |
| II-59 | 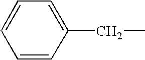 | 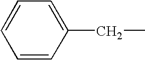 | TsO* |
| II-60 | C₇H₁₅— | Ph— | PF₆ |
| II-61 | C₇H₁₅— | C₅H₁₁— | PF₆ |
| II-62 | 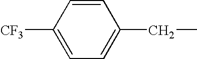 | Ph— | TsO* |

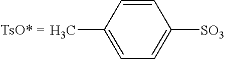

(G type)

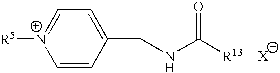

| | R⁵ | R¹³ | X |
|---|---|---|---|
| II-63 | 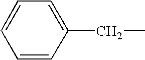 | CH₃— | PF₆ |
| II-64 | 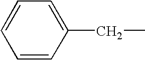 | Ph— | PF₆ |
| II-65 | H | Ph— | TsO |
| II-66 | C₇H₁₅— | CH₃— | BF₄ |
| II-67 | C₇H₁₅— | Pr— | PF₆ |

Of these polymerization initiators, preferred are aromatic ketones and triazines having structures shown below. As the aromatic ketones, preferred are also IRGACURE 184 (trade name) and other commercially available products.

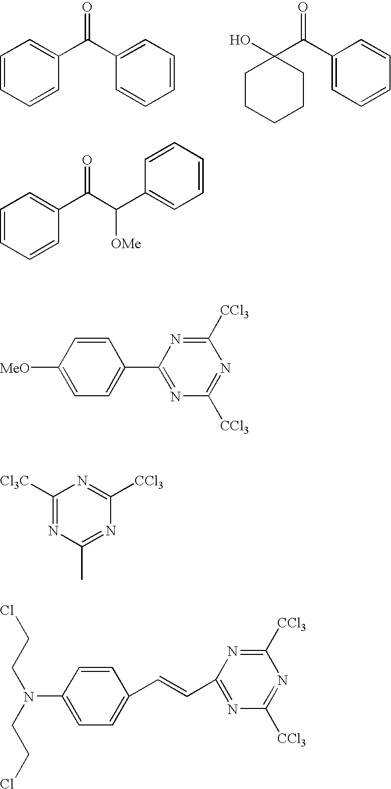

Of the above-mentioned aromatic ketone (a), onium salt compound (b), organic peroxide (c), thiol compound (d), hexaarylbiimidazole compound (e), ketoxime ester compound (f), borate compound (g), azinium compound (h), active ester compound (i), compound having a carbon-halogen bond, and pyridinium compound (k), and other polymerization initiators, particularly preferred are the above-mentioned compounds (a) to (k), which each have a thiol terminal, chlorosilane terminal or alkoxysilane terminal since the compounds are each a molecule capable of forming an SAM (self assembled monolayer).

Specific examples thereof include compounds having a carbon-halogen bond having a chlorosilane terminal (for example, P1 illustrated below), and aromatic ketones having a chlorosilane terminal (for example, P2 illustrated blow).

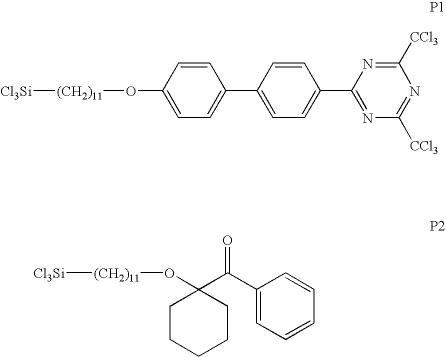

About the polymerization initiator, one species thereof may be used or two or more species thereof may be used in combination.

When the coating amount of the polymerization initiator is represented by use of the mass of the initiator after the initiator is dried, the amount is preferably from 0.1 to 15 g/m², more preferably from 2 to 8 g/m². When the coating amount is 0.1 g/m² or more, the polymerization initiator contributes sufficiently to graft polymerization so that a sufficient amount of a graft polymer may be produced. Thus, a desired graft structure is obtained. When the amount is 15 g/m² or less, a deterioration in the film property is prevented and the film is not easily peeled.

—Pattern Forming Step—

The pattern forming step is a step of bringing a compound having a polymerizable unsaturated bond into contact with the polymerization initiator fixed on the support, so as to conduct graft polymerization, thereby forming a pattern of a graft polymer.

In the invention, the method for producing a graft polymer on the surface of a layer made of the polymerization initiator fixed to the support (the layer may be referred to as a “polymerization initiating layer” hereinafter) may be a method that is generally called surface graft polymerization. Graft polymerization is a method of giving an active species onto a polymerization initiating layer, thereby bonding and polymerizing a different monomer which should be caused to start to polymerize, so as to synthesize a graft polymer. This method is called surface graft polymerization when the polymerization initiator for giving the active species forms a surface of a solid. The graft polymer produced by the invention includes, in the category thereof, a product obtained by bonding a desired polymer to the active species on the polymerization initiating layer. In the invention, the polymerizable-unsaturated-bond-having compound, to which the active species is given, becomes a polymer compound which constitutes the fixed graft polymer layer.

The method using graft polymerization to produce the graft polymer to form the graft polymer layer on the support may be, for example, a method of immersing the support on which the polymerization initiating layer is formed in the form of a pattern image into a composition containing a polymerizable-unsaturated-bond-having compound (referred to as the “graft polymer layer composition” hereinafter), or coating the graft polymer layer composition solution on the support, radiating light to the resultant to generate an active species, and then graft-polymerizing the compound onto the active species.

The polymerizable-unsaturated-bond-having compound used in this graft-polymer-producing process using graft polymerization, and other components useful for forming the pattern will be described hereinafter.

(Polymerizable-Unsaturated-Bond-Having Compound)

The polymerizable-unsaturated-bond-having compound used in the invention may be selected at will from compounds each having one or more, preferably two or more terminal ethylenically unsaturated bonds. The compound is, for example, in the form of a monomer or a prepolymer (that is, a dimer, a trimer or an oligomer), or in the form of a mixture thereof or a copolymer thereof, in some other chemical form.

Examples of the monomer and the copolymer thereof include esters each made from an unsaturated carboxylic acid (such as acrylic acid, methacrylic acid, itaconic acid, crotonic acid, isocrotonic acid or maleic acid) and an aliphatic polyhydric alcohol compound; and amides each made from an unsaturated carboxylic acid and an aliphatic polyhydric amine compound.

Specific examples of esters between aliphatic polyhydric alcohols and unsaturated carboxylic acids as the monomer include: acrylic acid esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol pentaacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, and polyester acrylate oligomers;

methacrylic acid esters such as tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, dipentaerythritol pentamethacrylate, sorbitol trimethacrylate, sorbitol tetrametharylate, bis[p-(3-methacryloxy-2-hydroxypropoxy)phenyl]dimethylmethane, and bis[p-(methacryloxyethoxy)phenyl]dimethylmethane;

itaconic acid esters such as ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate;

crotonic acid esters such as ethylene glycol dicrotonate, tetramethylene glycol dicrotonate, pentaerythritol dicrotonate, and sorbitol tetradicrotonate;

isocrotonic acid esters such as ethylene glycol diisocrotonate, pentaerythritol diisocrotonate, and sorbitol tetraisocrotonate; and

maleic acid esters such as ethylene glycol dimaleate, triethylene glycol dimaleate, pentaerythritol dimaleate, and sorbitol tetramaleate. Further the ester monomers described above may be used in combination of two or more thereof.

Specific examples of the monomer constituted by an amide of an aliphatic polyvalent amine and an unsaturated carboxylic acid further include methylenebis-acrylamide, methylenebis-methacrylamide, 1,6-hexamethylenebis-acrylamide, 1,6-hexamethylenebis-methacrylamide, diethylenetriamine trisacrylamide, xylilenebisacrylamide and xylilenebismethacrylamide.

Another example is a vinyl urethane compound having two or more polymerizable vinyl groups in a molecule prepared by adding a vinyl monomer having a hydroxyl group represented by formula (A) below to a polyisocyanate compound having two or more isocyanate groups in a molecule described in JP-B No. 48-41708.

CH₂═C(R³)COOCH₂CH(R⁴)OH Formula (A)

wherein R³ and R⁴ represent H or CH₃.

Other examples include polyfunctional acrylates and methacrylates such as urethane acrylates described in JP-A No. 51-37193 and JP-B No. 2-32293; polyester acrylates described in JP-A No. 48-64183, and JP-B Nos. 49-43191 and 52-30490; and epoxy acrylates prepared by allowing epoxy resins to react with (meta)acrylic acid. Additional examples of the polymerization initiator that may be used are compounds as photocurable monomers and oligomers introduced in the Journal of the Adhesion Society of Japan, vol. 20, No. 7, pages 300 to 308 (1984). The use amount thereof is from 5 to 70% by mass, preferably from 10 to 50% by mass of all the components.

Different examples of the polymerization initiator that is preferably used include addition polymerizable unsaturated compounds each having two or more terminal ethylene groups and described in U.S. Pat. Nos. 2,760,863 and 3,060,023, JP-A No. 62-121448, and others. Photopolymerization initiators in the patent publications are also preferred as the polymerization initiator in the invention.

In the case of using a support having a hydrophobic surface as the support to which the polymerization initiating layer is fixed, it is preferred to use a hydrophilic monomer or polymer as the polymerizable-unsaturated-bond-having compound. The use of the hydrophilic monomer or polymer is also preferred since the monomer or polymer easily interacts on magnetic particles. It is preferred to use a monomer or polymer which is hydrophobic but polar.

Examples of the hydrophilic monomer or polymer, or the monomer or polymer which is hydrophobic but polar include hydrophilic monomers having a polymerizable unsaturated bond, hydrophilic macromonomers having a polymerizable unsaturated bond, and hydrophilic polymers having a polymerizable unsaturated bond, these compounds being described below. These are each polymerized (or bonded), thereby producing a graft polymer excellent in hydrophilicity.

(Hydrophilic Monomer Having a Polymerizable Unsaturated Bond)

The hydrophilic monomer having a polymerizable unsaturated bond (hereinafter referred to as the polymerizable-group-containing hydrophilic monomer) is a monomer having, in the molecule thereof, an introduced ethylenical addition-polymerizable unsaturated group, such as a vinyl, allyl or (meth)acrylic group, and having a hydrophilic functional group.

Examples of the hydrophilic functional group that the polymerizable-group-containing hydrophilic monomer has include carboxylic acid, sulfonic acid, sulfinic acid, phosphoric acid and amino groups, and salts thereof; and amide, hydroxyl, ether, and polyoxyethylene groups.

Particularly useful and specific examples of the polymerizable-group-containing hydrophilic monomer in the invention include the following monomers: (meth)acrylic acid, alkali metals thereof and amine salts thereof; itaconic acid, alkali metals thereof and amine salts thereof; allylamine, and halogenated hydroacid salts thereof; 3-vinylpropionic acid, alkali metals thereof and amine salts thereof; vinylsulfonic acid, alkali metals thereof and amine salts thereof; styrenesulfonic acid, alkali metals thereof and amine salts thereof; 2-sulfoethylene(meth)acrylate, 3-sulfopropylene(meth)acrylate, alkali metals thereof and amine salts thereof; 2-acrylamide-2-methylpropanesulfoniac acid, alkali metals thereof and amine salts thereof; acid phosphooxypolyoxyethylene glycol mono(meth)acrylate, and salts thereof; 2-dimethylaminoethyl(meth)acrylate, and halogenated hydroacid salts thereof; and 3-trimethylammonium propyl(meth)acrylate, 3-trimethylammonium propyl(meth)acrylamide, and N,N,N-trimethyl-N-(2-hydroxy-3-methacryloyloxypropyl)ammonium chloride. Other useful examples thereof include 2-hydroxyethyl(meth)acrylate, (meth)acrylamide, N-monomethylol(meth)acrylamide, N-dimethylol(meth)acrylamide, N-vinylpyrrolidone, N-vinylacetoamide, and polyoxyethylene glycol mono(meth)acrylate.

Examples of the monomer which is hydrophobic but polar include 2-vinylpyridine, 4-vinylpyridine, and N-vinylimidazole.

(Hydrophilic Macromonomer Having a Polymerizable Unsaturated Bond)

The hydrophilic macromonomer having a polymerizable unsaturated bond (hereinafter referred to as the polymerizable-group-containing hydrophilic macromonomer) which may be used in the invention is a macromonomer having, in the molecule thereof, an introduced ethylenical addition-polymerizable unsaturated group, such as a vinyl, allyl or (meth)acrylic group, and having a hydrophilic functional group. Particularly useful examples of the hydrophilic macromonomers having polymerizable group employable herein include macromonomers derived from carboxyl group-containing monomers such as acrylic acid and methacrylic acid, sulfonic acid-based macromonomers derived from monomers such as 2-acrylamide-2-methyl propanesulfonic acid, styrenesulfonic acid and salt thereof, amide-based macromonomers derived from acrylamide, methacrylamide and the like, amide-based macromonomers derived from N-vinylcarboxylic acid amide monomer, such as N-vinyl acetamide, N-vinylformamide and the like, macromonomers derived from hydroxyl group-containing monomers such as hydroxyethyl methacrylate, hydroxyethyl acrylate and glycerol monomethacrylate, and macromonomers derived from alkoxy group or ethylene oxide group-containing monomers such as methoxyethyl acrylate, methoxypolyethylene glycol acrylate and polyethylene glycol acrylate. Further, monomers having a polyethylene glycol chain or polypropylene glycol chain, too, can be used as macromonomers of the invention.

About the method of manufacturing these macromonomers, various producing processes are suggested in, for example, Chapter 2 “Synthesis of Macromonomer” in “Chemistry and Industry of Macromonomers” (editor: Yuuya Yamashita) published by Industrial Publishing & Consulting, Inc. on Sep. 20, 1989. The molecular weight of useful one among these hydrophilic macromonomers is preferably from 250 to 100,000, particularly from 400 to 30,000.

(Hydrophilic Polymer Having a Polymerizable Unsaturated Bond)

The hydrophilic polymer having a polymerizable unsaturated bond (hereinafter referred to as the polymerizable-group-containing hydrophilic polymer) which may be used in the invention is a polymer having, in the molecule thereof, an introduced ethylenical addition-polymerizable unsaturated group, such as a vinyl, allyl or (meth)acrylic group, and having a hydrophilic functional group.

Specific examples of the polymerizable-group-containing hydrophilic polymer which may be used in the invention include hydrophilic homopolymers or copolymers which are each obtained using at least one selected from the specific examples of the polymerizable-group-containing hydrophilic monomer and the polymerizable-group-containing hydrophilic macro monomer.

In the case of using, as the polymerizable-unsaturated-bond-having compound, the polymerizable-group-containing hydrophilic polymer, a chain polymerization reaction is not necessarily required when the compound is graft-polymerized on the surface of the polymerization initiating layer. Accordingly, it is sufficient that a small amount of the polymerizable group is caused to react.

In the case of using, as the support to which the polymerization initiating layer is fixed, a support having a hydrophilic surface, it is preferred to use a hydrophobic compound as the polymerizable-unsaturated-bond-having compound. Examples of the hydrophobic compound include (meth)acrylic acid esters, styrene, and other hydrophobic monomers. These hydrophobic compounds are each polymerized (or bonded) to produce a graft polymer.

In the invention, the content by percentage of the polymerizable-unsaturated-bond-having compound is preferably from about 5 to 95% by mass, preferably from 5 to 80% by mass of the whole of solids in the graft polymer layer composition.

(Alkali-Soluble High-Molecular Compound)

The graft polymer layer composition in the invention preferably contains an alkali-soluble high-molecular compound to improve the film property. Examples of the alkali-soluble high-molecular compound include a polyhydroxystyrene, a hydroxystyrene-N-substituted maleimide copolymer, a hydroxystyrene-maleic anhydride copolymer, an acrylic polymer having an alkali-soluble group, and a urethane type polymer having an alkali-soluble group. Examples of the alkali-soluble group include carboxyl, phenolic hydroxyl, sulfonic acid, and phosphoric acid, and imide groups.

In the case of using a hydroxystyrene based polymer, such as poly-p-hydroxystyrene, poly-m-hydroxystyrene, p-hydroxystyrene-N-substituted maleimide copolymer, or p-hydroxystyrene-maleic anhydride copolymer, the mass average molecular weight thereof is preferably from 2,000 to 500,000, more preferably from 4,000 to 300,000.

Examples of the acrylic polymer having an alkali-soluble group include methacrylic acid-benzyl methacrylate copolymer, poly(hydroxyphenylmethacrylamide), poly(hydroxyphenylcarbonyloxyethyl acrylate), poly(2,4-dihydroxyphenylcarbonyloxyethyl acrylate), and polymers described in Japanese Patent Application No. 8-211731. The mass average molecule of these acrylic polymers is preferably from 2,000 to 500,000, more preferably from 4,000 to 300,000.

Examples of the urethane type polymer having an alkali-soluble group include resins each obtained by causing diphenylmethane diisocyanate to react with hexamethylene diisocyanate, tetraethylene glycol, or 2,2-bis(hydroxymethyl)propionic acid.

Among these alkali-soluble polymers, preferred are a hydroxystyrene based polymer, and an acrylic copolymer having an alkali-soluble group from the viewpoint of the developability thereof.

In the invention, the alkali-soluble high-molecular compound may be protected by an acid-decomposable group, such as an ester group or a carbamate group.

In the invention, the content by percentage of the alkali-soluble high-molecular compound is preferably from about 10 to 90% by mass, more preferably from 20 to 85% by mass, even more preferably from 30 to 80% by mass of the whole of solids in the graft polymer layer composition. When the content of the alkali-soluble high-molecular compound is 10% by mass or more, the graft polymer layer is excellent in endurance. When the content is 90% by mass or less, a fall in the sensitivity is prevented and a fall in the endurance of the graft polymer layer is prevented.

About the alkali-soluble high-molecular compound, only one species thereof may be used, or two or more species thereof may be used in combination.

As the alkali-soluble high-molecular compound, a linear organic high-molecular polymer may be used. The linear organic high-molecular polymer may be any linear organic high-molecular polymer. The polymer is preferably selected from linear organic high-molecular polymers soluble in water or weakly alkaline water or swellable with the same, which may be developed with water or weakly alkaline water. The linear organic high-molecular polymer is selected for use as an agent for forming a coating for the composition, and is selected for use in accordance with the use manner of a water, weakly alkaline or organic solvent developer. In the case of using, for example, a water-soluble linear organic high-molecular polymer, development with water is permissible.

The linear organic high-molecular polymer may be an addition polymer having a carboxylic acid group at its side chain, examples thereof including addition polymers described in JP-A Nos. 59-44615, 54-92723, 59-53836 and 59-71048, and JP-B Nos. 54-34327, 58-12577, and 54-25957, that is, methacrylic acid copolymer, acrylic acid copolymer, itaconic acid copolymer, crotonic acid copolymer, maleic acid copolymer, partially-esterified maleic acid copolymer, and so on. The linear organic high-molecular polymer may be an acidic cellulose derivative having a carboxylic acid group as its side chain. Besides, useful are a polymer wherein a cyclic acid anhydride is added to an addition polymer having a hydroxyl group, and other polymers.

Among these polymers, [benzyl (meth)acrylate/(meth)acrylic acid/an optional different addition-polymerizable vinyl monomer]copolymer and [ally (meth)acrylate/(meth)acrylic acid/an optional different addition-polymerizable vinyl monomer]copolymer are particularly preferred as the alkali-soluble high-molecular compound since the balance between the film strength, the sensitivity and the developability is good.

Moreover, a high-molecular binder described in JP-A No. 11-171907, which has an amide group and is soluble in alkaline water, is also preferred as the alkali-soluble high-molecular compound since the compound has both of excellent developability and film strength.

In an preferred exemplary embodiment, the alkali-soluble high-molecular compound is a high-molecular compound which is substantially insoluble in water and is soluble in alkali. In this way, an organic solvent unpreferable for environment is not used as a developer or the use amount of the developer is limited to a very small amount. In such a use manner, the acid value (the content of an acid represented by using the unit of chemical equivalent per gram of a polymer) of the alkali-soluble high-molecular compound and the molecule thereof are appropriately selected from the viewpoint of film strength and developability. The acid value is preferably from 0.4 to 3.0 meq/g, more preferably from 0.6 to 2.0 meq/g, and the molecule is preferably from 3,000 to 500,000, more preferably from 10,000 to 300,000.

(Other Components)

If necessary, various compounds other than the above-mentioned components may be incorporated into the graft polymer layer composition in the invention to give various properties to the composition.

[Thermal Polymerization Inhibitor]

It is desired to add, to the graft polymer layer composition in the invention, a thermal polymerization inhibitor in a small amount in order to inhibit unnecessary thermal polymerization of the polymerizable-unsaturated-bond-having compound when the graft polymer layer is produced or stored. Suitable examples of the thermal polymerization inhibitor include hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol), a cerium (III) salt of N-nitrosophenylhydroxyamine, and an ammonium salt of N-nitrosophenylhydroxylamine. The addition amount of the thermal polymerization inhibitor is from about 0.01 to 5% by mass of nonvolatile components in the graft polymer layer composition. In order to prevent oxygen from inhibiting the polymerization, a higher fatty acid derivative, such as behenic acid or behenic acid amide, or some other compound may be added to the composition if necessary, so as to distribute the compound unevenly in the graft polymer layer surface in the step of drying the composition after the coating thereof. The addition amount of the higher fatty acid derivative is preferably from about 0.5 to 10% by mass of the nonvolatile components in the graft polymer layer composition.

The solvent wherein the polymerizable-unsaturated-bond-having compound is to be dissolved is not particularly limited as long as the solvent is a solvent wherein the polymerizabl e-unsaturated-bond-having compound or optionally added additives are soluble. Examples of the solvent include ethylene dichloride, cyclohexanone, methyl ethyl ketone, methano 1, ethanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethylsulfoxide, sulfolan, γ-butylolactone, toluene, water and the like. The solvent for the invention is not limited to these solvents.

Among them, an aqueous solvent is preferable such as water or a water-soluble solvent, or a mixture thereof. At least one surfactant may be added to the solvent. The water-soluble solvent refers to a solvent miscible with water at any mixing rate. Examples of the water-soluble solvent include alcohols such as methanol, ethanol, propanol, ethylene glycol and glycerin, acids such as acetic acid, ketones such as acetone, and amides such as formamide.

These solvents may be used alone or in the form of a mixture of two or more thereof. The concentration of the graft polymer layer composition (all solids) in the solvent is preferably from 1 to 50% by mass to control the rate of the polymerization.

[Surfactant]

In order to improve the coatability of a solution of the graft polymer layer composition onto the polymerization initiating layer, the following may be added to the graft polymer layer composition in the invention: a nonionic surfactant as described in JP-A No. 62-251740 or 3-208514; an amphoteric surfactant as described in JP-A No. 59-121044 or 4-13149; or a fluorine-containing surfactant as described in JP-A No. 62-170950.

Specific examples of the nonionic surfactant include sorbitan tristearate, sorbitan monopalmitate, sorbitan trioleate, monoglyceride stearate, and polyoxyethylene nonylphenyl ether.

Specific examples of the amphoteric surfactant include alkyldi(aminoethyl)glycine, alkylpolyaminoethylglycine hydrochloride, 2-alkyl-N-carboxyethyl-N-hydroxyethylimidazolinium betaine, and N-tetradecyl-N,N-betaine type surfactants (for example, trade name: AMOGEN K, manufactured by Dai-ichi Kogyo Seiyaku Co., Ltd.). The ratio by mass of the nonionic surfactant or the amphoteric surfactant in the polymerization initiating layer (all solids) is preferably from 0.05 to 15% by mass, more preferably from 0.1 to 5% by mass.

A specific example of the fluorine-containing surfactant is a copolymer made from i) an acrylate or methacrylate containing a fluoroaliphatic group having 3 to 20 carbon atoms, containing fluorine in an amount of 40% by weight or more, and having, at its terminal moiety, at least three sufficiently-fluorinated carbon atoms, and ii) poly(oxyalkylene)acrylate or poly(oxyalkylene)methacrylate. The addition amount of the fluorine-containing surfactant is preferably from 0.01 to 1% by mass, more preferably from 0.05 to 0.5% by mass of all solids in the graft polymer layer composition solution.

[Plasticizer]

It is preferred to add a plasticizer to the graft polymer layer composition in the invention as the need arises, for example, in order to give flexibility or the like to the coated film. For example, butylphthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl oleate, oligomers and polymers of acrylic acid, or methacrylic acid are employed.

[Other Additives]

It is allowable to add, to the graft polymer layer composition in the invention, the above-mentioned onium salt, s-triazine substituted with a haloalkyl group, an epoxy compound, a vinyl ether, a phenol compound having a hydroxymethyl group and described in Japanese Patent Application No. 7-18120, a phenol compound having an alkoxymethyl group, and/or the like besides the above-mentioned components.

Examples (G1 to G8) of the graft polymer constitutional unit which constitutes the graft polymer are illustrated below. However, the constitutional unit for the graft polymer in the invention is not limited to these examples.

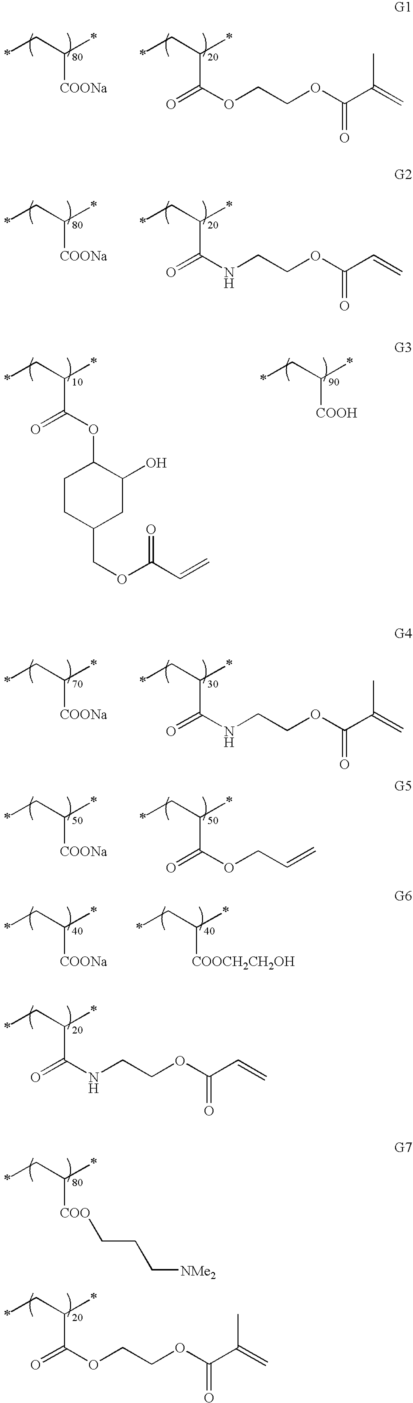

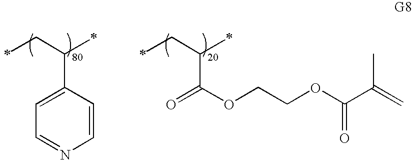

The coating amount of the graft polymer layer composition solution is set in such a manner that the mass per unit area of the solution is preferably from 0.1 to 20 g/m², more preferably from 2 to 15 g/m² after the solution is coated and dried. When the mass per unit area is 0.1 g/m² or more, the solution exhibits a sufficient polymerization initiating power so that graft polymerization may be sufficiently conducted. Thus, a desired strong graft structure may be obtained. When the mass per unit area is 20 g/m² or less, the resultant film is not easily peeled so that a fall in the film property may be prevented.

[Supply of Energy for Giving an Active Species to Phe polymerization Initiating Layer]

The method for supplying energy for giving an active species to the polymerization initiating layer is not particularly limited as long as the method is a method capable of supplying energy capable of decomposing the polymerization initiator in the polymerization initiating layer. The method is preferably, for example, a method of radiating an active beam, such as radiation of light, from the viewpoint of costs and simplicity of the apparatus therefof.

As the active beam usable for supplying energy, ultraviolet rays, visible rays and infrared rays are mentioned. However, among these active beams, ultraviolet rays and visible rays are preferable, and ultraviolet rays are preferable in particular, from the viewpoint of being superior in polymerization speed. The main wave length of the active beam is preferably between 250 nm and 800 nm.

Examples of the light source include a low pressure mercury lamp, a high pressure mercury lamp, a fluorescent lamp, a xenon lamp, a carbon arc lamp, a tungsten incandescent lamp, sun light and the like.

The required time for irradiation of the active beam is usually several seconds to 24 hours depending on the preparation density of a target graft polymer and a light source used.

The thickness of the graft polymer layer made of the graft polymer produced as described above is preferably from 0.001 to 10 g/m², more preferably from 0.01 to 5 g/m². When the thickness of this pattern is 0.001 g/m² or more, hydrophilicity may be effectively expressed. When the thickness of the pattern is 10 g/m² or less, in the use of the formed patterned material as a light transmissible material a decrease in the transmittance may be restrained.

The graft polymer produced as described above is excellent in endurance since the polymer is bonded directly to the polymerization initiating layer.

In the invention, the wording “excellent in hydrophilicity” about the graft polymer means a state that the polymer exhibits a water wettability permitting the contact angle between the polymer and water to be 20° or less. The method for measuring the contact angle may be a known method, for example, a method of measuring the contact angle (water droplet in the air) with a commercially available device, for example, a device (trade name: CAN-Z) manufactured by Kyowa Interface Science Co., Ltd. When the contact angle is 20° or less according to this method, it is judged that the excellent hydrophilicity in the invention is attained.

According to the above-mentioned pattern forming step in the invention, a polymerization initiating layer is beforehand formed into the form of a patterned image and then a graft polymer is produced on the polymerization initiating layer. In the pattern formed by this step, a clear boundary may be supplied between its hydrophilic regions and its hydrophobic regions. Thus, the final product is easily applied to various articles for which fineness or minuteness is required.

—Magnetic Region Forming Step—

The magnetic region forming step is a step of coating, onto the pattern, an alloy-particle-containing liquid which contains alloy particles capable of forming a CuAu pattern or Cu₃Au pattern ferromagnetic ordered alloy, and further subjecting the resultant to annealing processing, thereby forming magnetic regions physically independent of each other.

In such a way, an alloy-particle-containing liquid which contains alloy particles capable of forming a CuAu pattern or Cu₃Au pattern ferromagnetic ordered alloy is coated on the pattern (the graft polymer layer) on the support to form magnetic regions physically independent of each other, thereby decreasing transition noises.

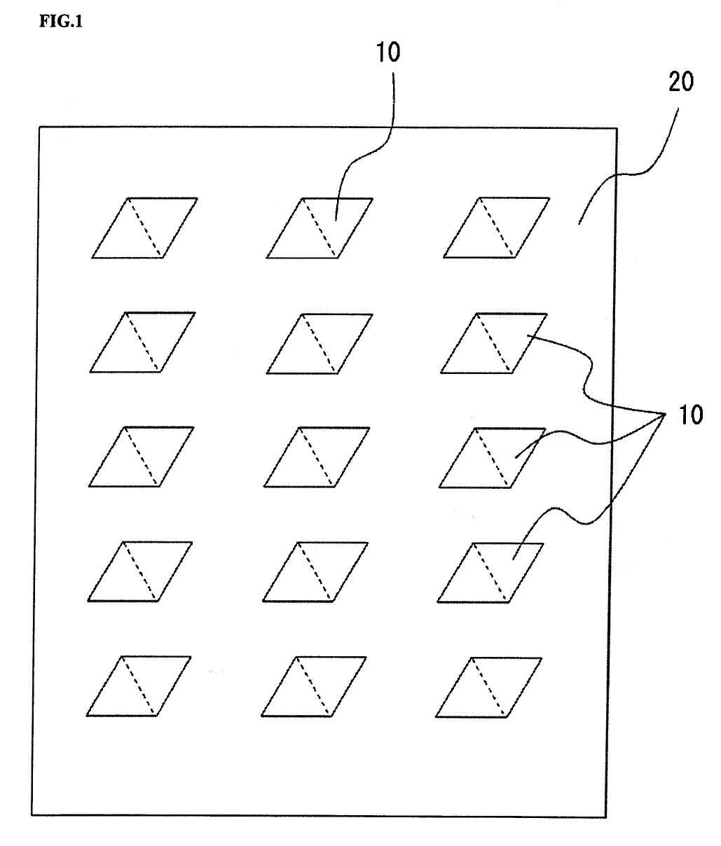

In the invention, the wording “magnetic regions physically independent of each other” means a situation as illustrated in FIG. 1, that is, a situation that a substantially nonmagnetic substance (nonmagnetic region) 20 is present between magnetic regions 10. When the magnetic regions 10 are made of convexes extending from the support, the nonmagnetic substance is air. When the magnetic regions 10 are embedded in the support, the nonmagnetic substance is the support or a matrix layer which will be detailed later. In the following description, the reference numbers will be omitted as the case may be.

About the magnetic regions, magnetic particles are desirably self-aligned inside the regions. According to this, the inside of the magnetic regions becomes even so that an effect of decreasing noises may be expected. Since the magnetic particles are usually spherical, the magnetic regions are each preferably in the following form in order to cause the magnetic particles to be self-aligned: the form of an equilateral triangle or a polygon composed of equilateral triangles as bases, that is, the form of a lozenge, which is composed of two equilateral triangles, a trapezoid, which is composed of equilateral triangles the number of which is odd, a parallelogram, which is composed of equilateral triangles the number of which is even, or a hexagon, which is composed of six equilateral triangles.

About the size of each of the magnetic regions when the region is in the form of a point or line, the shortest distance in the form (for example, its short side or diagonal) is preferably from 20 to 1000 nm, more preferably from 25 to 500 nm. The magnetic regions are preferably magnetically independently of each other in order to decrease transition noises still more. It is therefore desired that the distance between the magnetic regions is larger. However, when the distance is too large, the recording density unfavorably becomes low. Thus, this distance (the minimum interval) is preferably from 5 to 200 nm, more preferably from 10 to 100 nm.

The following will describe the magnetic particles which constitute the magnetic regions (particles made of a CuAu pattern or Cu₃Au pattern ferromagnetic ordered alloy).

(Production of the Alloy Particles)

Alloy particles whose alloy phase is a disordered phase, which will be magnetic particles (particles made of a CuAu pattern or Cu₃Au pattern ferromagnetic ordered alloy) by annealing processing that will be detailed later may be produced by a gas phase method or a liquid phase method.

From consideration of the superiority of mass production, the liquid phase method is preferred. Various of the conventionally known methods can be applied as the liquid phase method, but it is preferable that improved methods of these using a reduction method are used, and among reduction methods a reverse micelle method is particularly preferable, since it enables the control of the particle size.

The reverse micelle method includes at least the steps of (1) mixing two types of reverse micelle solutions so as to cause a reduction reaction (the reduction step) and (2) performing aging at a specific temperature after the reduction reaction (the aging step).

(1) Reduction Step

First, a mixture of a surfactant-containing water-insoluble organic solvent and an aqueous solution of a reducing agent is prepared as a reverse micelle solution (I). An oil-soluble surfactant may be used as the surfactant. Examples of such a surfactant include sulfonate type surfactants (such as AEROSOL OT (trade name, manufactured by Wako Pure Chemical Industries, Ltd.)), quaternary ammonium salt type surfactants (such as cetyltrimethylammonium bromide) and ether type surfactants (such as pentaethylene glycol dodecyl ether).

The content of the surfactant in the water-insoluble organic solvent is preferably from 20 to 200 g/l.

The water-insoluble organic solvent for dissolving the surfactant is preferably an alkane, an ether, alcohol or the like. The alkane is preferably of 7 to 12 carbon atoms. Examples of such an alkane include heptane, octane, isooctane, nonane, decane, undecane, and dodecane. The ether is preferably diethyl ether, dipropyl ether, dibutyl ether, or the like. The alcohol is preferably ethoxyethanol, ethoxypropanol or the like.

One or more of alcohols, polyols, H₂, and compounds having H₂, HCHO, S₂O₆²⁻, H₂PO₂⁻, BH₄⁻, N₂H₅⁺, H₂PO₃—, or the like may preferably be used alone or in combination as the reducing agent in the aqueous solution. The amount of the reducing agent in the aqueous solution is preferably from 3 to 50 moles per mole with respect to one mole of the metal salt.

In this method, the mass ratio of water to the surfactant in the reverse micelle solution (I) (water/surfactant) is preferably 20 or less. If such a mass ratio is 20 or less, advantageously, precipitation can be suppressed, and the particle size can easily be uniform. The mass ratio is more preferably 15 or less, even more preferably from 0.5 to 10.

Another mixture of a surfactant-containing water-insoluble organic solvent and an aqueous solution of a metal salt is independently prepared as a reverse micelle solution (II). The conditions of the surfactant and the water-insoluble organic solvent (such as materials for use and concentration) may be the same as those of the reverse micelle solution (I). The type of the reverse micelle solution (II) for use may be the same as or different from that of the reverse micelle solution (I). Similarly, the mass ratio of water to the surfactant in the reverse micelle solution (II) may be the same as or different from that of the micelle solution (I).

It is preferred that the metal salt for forming the aqueous solution should be appropriately selected in such a manner that the magnetic particles can form a CuAu— or Cu₃Au— pattern ferromagnetic ordered alloy.

Examples of the CuAu— pattern ferromagnetic ordered alloy include FeNi, FePd, FePt, CoPt, and CoAu. Particularly preferred are FePd, FePt and CoPt from the point of high Ku (magnetic anisotropy) and high Ms (magnetic susceptibility).

Examples of the Cu₃Au— pattern ferromagnetic ordered alloy include Ni₃Fe, FePd₃, Fe₃Pt, FePt₃, CoPt₃, Ni₃Pt, CrPt₃, and Ni₃Mn.

Examples of the metal salt include H₂PtCl₆, K₂PtCl₄, Pt(CH₃COCHCOCH₃)₂, Na₂PdCl₄, Pd(OCOCH₃)₂, PdCl₂, Pd(CH₃COCHCOCH₃)₂, HAuCl₄, Fe₂(SO₄)₃, Fe(NO₃)₃, (NH₄)₃Fe(C₂O₄)₃, Fe(CH₃COCHCOCH₃)₃, NiSO₄, CoCl₂, and Co(OCOCH₃)₂.

The concentration of the aqueous metal salt solution is preferably from 0.1 to 1000 μmol/ml, more preferably from 1 to 100 μmol/ml (in terms of the concentration of the metal salt).

By appropriate selection of the above metal salts, alloy particles can be manufactured, which can form CuAu— pattern or Cu₃Au— pattern ferromagnetic ordered alloys, formed by the alloying of metals with low redox potential and metals with high redox potential.

The alloy phase of the alloy particles should be transformed from the disordered phase to the ordered phase by annealing as described below. A third element such as Sb, Pb, Bi, Cu, Ag, Zn, and In is preferably added to the above binary alloy for the purpose of lowering the transforming temperature. A precursor of each third element is preferably added to the metal salt solution in advance. The third element is preferably added in an amount of 1 to 30 at %, more preferably of 5 to 20 at %, based on the amount of the binary alloy.

The reverse micelle solutions (I) and (II) prepared as shown above are mixed. Any mixing method may be used. For example, a preferred method includes adding the reverse micelle solution (II) to form a mixture while stirring the reverse micelle solution (I), in consideration of uniformity in reduction. After the mixing is completed, a reduction reaction is allowed to proceed, in which the temperature is preferably kept constant in the range from −5 to 30° C. When the reduction temperature is from −5 to 30° C., the problem of unevenness in reduction reaction by condensation of the aqueous phase can be eliminated, and the problem of easily causing aggregation or precipitation and making the system unstable can also be eliminated. The reduction temperature is preferably from 0 to 25° C., more preferably from 5 to 25° C.

Herein, the “constant temperature” means that when the target temperature is set at T (° C.), the temperature of the reduction reaction is in the range of T±3° C. Even in such a case, T also should have upper and lower limits in the above reduction temperature range (from −5 to 30° C.).

The time period of the reduction reaction should be appropriately set depending on the amount of the reverse micelle solution and the like, and is preferably from 1 to 30 minutes, more preferably from 5 to 20 minutes. The reduction reaction has a significant effect on monodispersion of the particle size distribution and thus is preferably performed with high speed stirring.

A stirrer with high shearing force is preferably used. Specifically, such a preferred stirrer comprises: an agitating blade basically having a turbine or puddle type structure; a structure of a sharp blade attached to the end of the agitating blade or placed at the position in contact with the agitating blade; and a motor for rotating the agitating blade. Useful examples thereof include Dissolver (trade name, manufactured by TOKUSHU KIKA KOGYO CO., LTD.), Omni-Mixer (trade name, manufactured by Yamato Scientific Co., Ltd.), and a homogenizer (manufactured by SMT Company). A stable dispersion of monodisperse alloy particles can be prepared using any of these stirrers.

At least one dispersing agent having one to three amino or carboxyl groups is preferably added to at least one of the reverse micelle solutions (I) and (II), in an amount of 0.001 to 10 moles per mole of the alloy particles to be prepared. If such a dispersing agent is added, more monodisperse aggregation-free alloy particles can be produced. When the addition amount is from 0.001 to 10 moles, the monodispersion of the alloy particles can further be improved while aggregation can be suppressed.

For the above dispersant, preferably used are organic compounds containing groups which can adsorb to the surface of the alloy particles. Specifically, compounds with one to three of amino groups, carboxyl groups, sulfonic acid groups or sulfinic acid groups can be used separately or in combinations.

Specific examples of the dispersing agent include the compounds represented by the structural formula: R—NH₂, NH₂—R—NH₂, NH₂—R(NH₂)—NH₂, R—COOH, COOH—R—COOH, COOH—R(COOH)—COOH, R—SO₃H, SO₃H—R—SO₃H, SO₃H—R(SO₃H)—SO₃H, R—SO₂H, SO₂H—R—SO₂H, or SO₂H—R(SO₂H)—SO₂H. In each formula, R is a straight chain, branched or cyclic, saturated or unsaturated hydrocarbon.

A particularly preferred dispersing agent is oleic acid, which is a known surfactant for colloid stabilization and has been used to protect particles of a metal such as iron. The relatively long chain of oleic acid can provide significant steric hindrance so as to cancel the strong magnetic interaction between particles. For example, oleic acid has an 18-carbon atom chain and a length of 20 angstroms (2 nm) or less. Oleic acid is not aliphatic but has a single double bond.

A similar long-chain carboxylic acid such as erucic acid and linolic acid may also be used as well as oleic acid. One or more of the long-chain organic acids having 8 to 22 carbon atoms may be used alone or in combination. Oleic acid is preferred because it is inexpensive and easily available from natural sources such as olive oil. Oleylamine, a derivative of oleic acid, is also a useful dispersing agent as well as oleic acid.

In a preferred mode of the above reduction step, a metal with a lower redox potential such as Co, Fe, Ni, and Cr (a metal with a potential of about −0.2 V (vs. N.H.E)) or less is considered to be reduced and precipitated in a minimal size and in a monodisperse state. Thereafter, in a preferred mode of the temperature rise stage and the aging step as described below, a metal with a high redox potential such as Pt, Pd and Rh (a metal with a potential of about −0.2 V (vs. N.H.E)) or more is reduced by the precipitated low-potential metal, which serves as a nucleus, at its surface, and replaced and precipitated. The ionized low-potential metal can be reduced again by the reducing agent and precipitated. Such cycles produce alloy particles capable of forming the CuAu— or Cu₃Au— pattern ferromagnetic ordered alloy.

(2) Aging Step

After the reduction reaction is completed, the resulting solution is heated to an aging temperature. The aging temperature is preferably a constant temperature of 30 to 90° C. Such a temperature should be higher than the temperature of the reduction reaction. The aging time period is preferably from 5 to 180 minutes. If the aging temperature and the aging time shift to a higher temperature side from the above range, aggregation or precipitation tend to occur. However, if the temperature and time shift to a lower temperature side, then a change in composition due to an incomplete reaction may occur. The aging temperature and the aging time are preferably from 40 to 80° C. and from 10 to 150 minutes, respectively, more preferably from 40 to 70° C. and from 20 to 120 minutes, respectively.

Herein, the “constant temperature” has the same meaning as in the case of the reduction temperature (provided that the phrase “reduction temperature” is replaced by the phrase “aging temperature”). Particularly in the above range (from 30 to 90° C.), the aging temperature is preferably 5° C. or more, more preferably 10° C. or more higher than the reduction reaction temperature. If the aging temperature is 5° C. or more higher than the reduction temperature, the composition as prescribed can be obtained easily.

In the aging step as shown above, the high-potential metal is deposited on the low-potential metal which is reduced and precipitated in the reduction step. Specifically, the reduction of the high-potential metal occurs only on the low-potential metal, and the high-potential metal and the low-potential metal are prevented from precipitating separately. Thus, the alloy particles capable of forming the CuAu— or Cu₃Au— pattern ferromagnetic ordered alloy can be efficiently prepared in high yield and in the composition ratio as prescribed so that they can be controlled to have the desired composition. A desired particle size of the alloy particles can be obtained by appropriately controlling the agitation speed during the aging process.

After the aging is performed, a washing and dispersing process is preferably performed, which includes the steps of: washing the resulting solution with a mixture solution of water and a primary alcohol; then performing a precipitation treatment with a primary alcohol to produce a precipitate; and dispersing the precipitate in an organic solvent. Such a washing and dispersing process can remove impurities so that the coating applicability on the pattern of the liquid including the alloy particles can further be improved. The washing step and the dispersing step should each be performed at least once, preferably twice or more.

Any primary alcohol may be used in the washing, and methanol, ethanol or the like is preferred. The mixing ratio (water/primary alcohol) by volume is preferably in the range from 10/1 to 2/1, more preferably from 5/1 to 3/1. By setting the mixing ratio (water/primary alcohol) by volume in the range from 10/1 to 2/1, the surfactant can easily be removed, and occurrence of aggregation of surfactant can be depressed.

Thus, a dispersion that comprises the alloy particles dispersed in the solution (an alloy particle-containing liquid) is obtained. The alloy particles are monodispersed and thus can be prevented from aggregating and can maintain a uniformly dispersed state even when applied to a support. The respective alloy particles can be prevented from aggregating even when annealed, and thus they can efficiently be ferro-magnetized and have good suitability for coating.

The diameter of the alloy particles before oxidation processing, which will be described later, is preferably small from the perspective of being able to lower noise. If it is too small then after annealing the particles can be suppressed to become superparamagnetic, and can be prevented from becoming not suitable for magnetic recording. Generally, it is preferable that the diameter is between 1 to 100 nm, more preferably 1 to 20 nm and most preferably 3 to 10 nm.

(Reduction Method)

There are various reduction methods for producing the alloy particles capable of forming the CuAu— or Cu₃Au— pattern ferromagnetic ordered alloy. It is preferred to use a method including the step of reducing at least a metal with a lower redox potential (referred to below as a low-potential metal) and a metal with a high redox potential (referred to below as a high-potential metal) with a reducing agent or the like in an organic solvent, water or a mixture solution of an organic solvent and water. The low-potential metal and the high-potential metal may be reduced in any order or may be reduced at the same time.

An alcohol, a polyalcohol or the like may be used as the organic solvent. Examples of the alcohol include methanol, ethanol and butanol. Examples of the polyalcohol include ethylene glycol and glycerol. Examples of the CuAu— or Cu₃Au— pattern ferromagnetic ordered alloy are the same as those in the case of the above reverse micelle method. The method of preparing the alloy particles through first-precipitation of the high-potential metal may employ the process disclosed in paragraphs 18 to 30 of JP-A No. 2003-73705, the disclosure of which is incorporated by reference herein.

The metal with a high redox potential is preferably Pt, Pd, Rh, or the like. Such a metal may be used by dissolving H₂PtCl₆.6H₂O, Pt(CH₃COCHCOCH₃)₂, RhCl₃.3H₂O, Pd(OCOCH₃)₂, PdCl₂, Pd(CH₃COCHCOCH₃)₂, or the like in a solvent. The concentration of the metal in the solution is preferably from 0.1 to 1000 μmol/ml, more preferably from 0.1 to 100 μmol/ml.

The metal with a lower redox potential is preferably Co, Fe, Ni, or Cr, particularly preferably Fe or Co. Such a metal may be used by dissolving FeSO₄.7H₂O, NiSO₄.7H2O, CoCl₂.6H₂O, Co(OCOCH₃)₂.4H₂O, or the like in a solvent. The concentration of the metal in the solution is preferably from 0.1 to 1000 μmol/ml, more preferably from 0.1 to 100 μmol/ml.

Similarly to the above reverse micelle method, a third element is preferably added to the binary alloy to lower the transforming temperature for the ferromagnetic ordered alloy. The addition amount may be the same as that in the reverse micelle method.

For example, the low-potential metal and the high-potential metal are reduced and precipitated in this order using a reducing agent. In such a case, a preferred process includes reducing the low-potential metal or the low-potential metal and part of the high-potential metal with a reducing agent having a reduction potential lower than −0.2 V (vs. N.H.E); adding the product of the reduction to the high-potential metal source and reducing it with a reducing agent having a redox potential higher than −0.2 V (vs. N.H.E); and then performing a reduction with a reducing agent having a reduction potential lower than −0.2 V (vs. N.H.E).

The redox potential depends on the pH of the system. Preferable examples of the reducing agent having a redox potential higher than −0.2 V (vs. N.H.E) include alcohols such as 1,2-hexadecanediol, glycerols; H₂, and HCHO. Preferable examples of the reducing agent having a potential lower than −0.2 V (vs. N.H.E) include S₂O₆²⁻, H₂PO₂⁻, BH₄⁻, N₂H₅⁺, and H₂PO₃⁻. In a case where a zero-valence metal compound such as Fe carbonyl is used as the raw material for the low-potential metal, the reducing agent for the low-potential metal does not have to be used.

The high-potential metal may be reduced and precipitated in the presence of an adsorbent so that the alloy particles can be stably prepared. The adsorbent is preferably a polymer or a surfactant.

Examples of the type of the polymer include polyvinyl alcohol (PVA), poly(N-vinyl-2-pyrolidone) (PVP) and gelatin. PVP is preferred.

The molecular weight of the polymer is preferably from 20,000 to 60,000, more preferably from 30,000 to 50,000. The amount of the polymer is preferably from 0.1 to 10 times, more preferably from 0.1 to 5 times the mass of the alloy particles to be produced.

The surfactant used as an adsorbent preferably includes an “organic stabilizing agent” which is a long-chain organic compound represented by the general formula: R—X, wherein R is a “tail group” of a linear or branched hydrocarbon or fluorocarbon chain and generally has 8 to 22 carbon atoms; and X is a “head group” which is a part for providing a specific chemical bond to the alloy particle surface and preferably any one of sulfinate (—SOOH), sulfonate (—SO₂OH), phosphinate (—POOH), phosphate (—OPO(OH)₂), carboxylate, and thiol.

The organic stabilizing agent is preferably any one of a sulfonic acid (R—SO₂OH), a sulfinic acid (R—SOOH), a phosphinic acid (R₂POOH), a phosphonic acid (R—OPO(OH)₂), a carboxylic acid (R—COOH), and a thiol (R—SH). Oleic acid is particularly preferred as in the reverse micelle method.

A combination of the phosphine and the organic stabilizing agent (such as triorganophosphine/acid) can provide good controllability for the growth and stabilization of the particles. Didecyl ether or didodecyl ether may also be used. Phenyl ether or n-octyl ether is preferably used as the solvent in terms of low cost and high boiling point.

The reduction reaction is preferably performed at a temperature in the range from 80 to 360° C., more preferably from 80 to 240° C., depending on the necessary alloy particles and the boiling point of the necessary solvent. When the temperature is in the range from 80 to 360° C., well controllable growth of particles can be facilitated, and the formation of undesired by-products can be inhibited.

The particle diameter of the alloy particles is preferably 1 to 100 nm, more preferably 3 to 20 nm, and still more preferably 3 to 10 nm, as in the case of alloy particles prepared by the reverse micelle method.

For a method to increase the particles size (particle diameter), an effective method is a seed crystal method. It is preferable that, in order to increase the recording volume, the alloy particles used for the magnetic recording medium are packed with maximum density. In order to do this, the standard deviation of the alloy particle size is preferably less than 10% of the mean particle size, and more preferably 5% or less. It is preferable that the coefficient of variation of the particle size is less than 10% and more preferably 5% or less.

If the particle size is too small they become superparamagnetic and this is not preferable. And so, as has been stated above, a seed crystal method can be used to increase the size of the particles. In this case, it is possible that a metal which is of higher redox potential than the metal comprising the particles is precipitated. In this case there is a fear of oxidation of the particles and so it is preferable that hydrogenation treatment is carried out on the particles in advance.

It is preferable that the outermost surface of the alloy particles is made from metal of high redox potential from the perspective of preventing oxidation, but since this makes the particles readily aggregate together, in the invention it is preferable to have an alloy of low and high redox potential metals. As has been stated above, such a constitution can be made easily and effectively realized by a liquid phase method.

It is preferable that salts are removed from the liquid after synthesizing the alloy particles in order to improve the stability of dispersion of the alloy particles. De-salting can be carried out by methods of adding an excess of alcohol, causing light aggregation, and then removing the salts together with the supernatant fluid after natural precipitation or precipitation with a centrifuge. However since aggregation can occur easily when using such methods it is preferable to use ultrafiltration methods. The dispersion of alloy particles in solvent (alloy particle containing liquid) can be obtained as above.

In the present step, an alloy-particle-containing liquid which contains alloy particles capable of forming a CuAu pattern or Cu₃Au pattern ferromagnetic ordered alloy is coated on the pattern (the graft polymer layer). In this way, an alloy-particle-containing layer is formed on the pattern. The alloy particles in the alloy-particle-containing layer is subjected to annealing processing or the like, which will be detailed later, to turn the alloy particles in the alloy-particle-containing layer to magnetic particles. As a result, the alloy-particle-containing layer becomes a magnetic layer so that magnetic regions are formed on the support.

If necessary, it is allowable to add, to the alloy-particle-containing layer, a matrix agent, which will be detailed below, or various additives. About the matrix agent, ones or more species thereof may be added. The content thereof is preferably from 0.007 to 1.0 μg/mL, more preferably from 0.01 to 0.7 μg/mL.

The matrix agent which may be added to the alloy-particle-containing liquid may be a known matrix agent, and is preferably a metal oxide matrix agent excellent in heat resistance. In a case where a metal oxide matrix agent has heat resistance, the pattern of the magnetic regions may favorably be maintained when high-temperature treatment is conducted by annealing processing or the like, which will be detailed later, so that the graft polymer is carbonized or disintegrated by high heat. This is because the magnetic regions are composed of the heat-resistant matrix agent and magnetic material.

The metal oxide matrix is preferably nonmagnetic. When the matrix is nonmagnetic, a nonmagnetic matrix layer (nonmagnetic region 20) is present between the magnetic regions 10, which is also illustrated in FIG. 1. Thus, the magnetic particles each having a single-domain do not contact each other so as to produce an effect that transition noises are further decreased in magnetic recording.

For the nonmagnetic metal oxide matrix, at least one type of a matrix agent selected from the group consisting of silica, titania or polysiloxane is preferable. Specifically it is preferable that the matrix agent is at least one type of matrix agent selected from the group consisting of organo-silica sols (for example, Trade Name: ORGANOSILICASOL, manufactured by Nissan Chemicals; and, Trade Name: NANOTEC SiO₂, manufactured by CI Kasei Co.), organo-titania sols (for example, Trade Name: NANOTEC TiO₂, manufactured by CI Kasei Co.) and silicone resins (for example, Trade Name:TOREFIL R910, manufactured by Toray Industries Inc.). The above materials are effective in increasing the resistance to scratches and adhesion of the magnetic layer. If the above matrix agents are the main components then, in addition to these, various known additives can be added into the magnetic layer.

When the magnetic-particle-containing layer (magnetic layer) is caused to be present in the form of points as the magnetic regions, the injury resistance of the magnetic regions may be made high and the adhesion between the regions and the pattern (graft polymer layer) may be made high while the regions have a high coercive force.

Here, it is possible to maintain a condition of high adhesion of the magnetic layer with the support since the metal oxide compound matrix exhibits the role of a binder, even when carrying out annealing to form the ferromagnetic ordered alloy. Further, even when annealing treatment is carried out, the constitution of the metallic oxide compound matrix does not alter, and since a strong magnetic layer is formed, deterioration of layer strength due to the carbonization of organic dispersant or polymer can be suppressed and scratch resistance can be improved.

Further, by including the magnetic particles into the matrix agent of the metal oxide matrix and the like, the magnetic particles do not aggregate together, and a condition of a high degree of dispersion can be maintained, and ferromagnetism can be effectively realized.

A transmission electron microscope (TEM) may be used for evaluation of the diameter of alloy particles. The crystal system of alloy or magnetic particles may be determined by TEM electron diffraction, but is preferably determined by X-ray diffraction in terms of high accuracy. In the composition analysis of the internal portion of alloy or magnetic particles, an EDAX is preferably attached to an FE-TEM capable of finely focusing the electron beam and used for the evaluation. The evaluation of the magnetic properties of the magnetic particles may be made using a VSM (vibrating sample magnetometer).

(Oxidation Treatment)

The alloy particles thus prepared may be subjected to the oxidation treatment. In the oxidation treatment, the alloy particles are oxidized. If the prepared alloy particles are oxidized, magnetic particles with ferromagnetism can efficiently be produced with no need for high temperature in the annealing which will be described later. This can result from the phenomenon as shown below.

In the oxidation of the alloy particles, first, oxygen enters into their crystal lattice. When the oxygen-containing alloy particles are annealed in the state where the oxygen enters into their crystal lattice, the oxygen is released from the crystal lattice by heat. Such release of the oxygen can cause defects, through which the metal atoms which constitutes the alloy become mobile so that the phase transformation can easily occur even at relatively low temperatures. For example, such a phenomenon can be estimated by EXAFS (Extended X-ray Absorption Fine Structure) measurement of the alloy particles after the oxidized treatment and the magnetic particles after the annealing treatment.

For example, in Fe—Pt alloy particles which have not been subjected to the oxidizing treatment, for example, the existence of a bond between Fe atoms and Pt or Fe atoms can be confirmed. In the alloy particles which have been subjected to the oxidizing treatment, the existence of a bond between Fe atoms and oxygen atoms can be confirmed, while a bond between Pt and Fe atoms can hardly be found. This means that the Fe—Pt or Fe—Fe bonds have been broken by the oxygen atoms. This suggests that the Pt or Fe atoms become mobile at the time of annealing. After the alloy particles are annealed, the existence of oxygen cannot be confirmed while the existence of bonds with Pt or Fe atoms can be confirmed around the Fe atoms.

It is apparent from the above phenomenon that the phase transformation is able to slowly proceed without oxidation and that in the annealing is required higher temperature without oxidation. It can be considered, however, that excessive oxidation can cause a too strong interaction between oxygen and easy-to-oxidize metals such as Fe so that metal oxides can be produced. Thus, it is important that the oxidation state of the alloy particles should be controlled. Therefore, the oxidation treatment conditions should be optimized.

When the alloy particles are produced by the liquid phase method or the like as described above, for example, the oxidation treatment may be performed by supplying a gas containing at least oxygen (such as oxygen gas and air) to the resulting alloy particle-containing liquid. At that time, the partial pressure of the oxygen is preferably from 10 to 100%, more preferably from 15 to 50% of the total pressure. The temperature of the oxidation treatment is preferably from 0 to 100° C., more preferably from 15 to 80° C.

The oxidized state of the alloy particles is preferably evaluated by EXAFS or the like. In view of the cleavage of the Fe—Fe or Pt—Fe bond by oxygen, the number of the bond or bonds between oxygen and the low-potential metal such as Fe is preferably from 0.5 to 4, more preferably from 1 to 3.

Also, for the oxidation treatment, this can be carried out by exposure in air at room temperature (0 to 40° C.), when the above alloy particles are coated on or fixed onto a support or the like. By undertaking the treatment in a state of coating on a support or the like, the aggregation of the alloy particles can be prevented. Regarding the time for the oxidation treatment, this is preferably between 1 and 48 hours, with 3 to 24 hours being more preferable.

Also, it is also possible to carry out the oxidation processing at the time of drying the coating film, after coating of the coating liquid in the process for forming the magnetic regions. At this time it is preferable that the temperature is between 100 and 300° C. And as long as there is oxygen present in the atmosphere, there is no particular restriction to the atmosphere for carrying out the oxidation process, and from the perspective of convenience, it is preferable that it can be carried out in air.

<Process of Annealing>

After the formation of the magnetic regions, the alloy particles present in the magnetic regions are of a non-ordered phase. Such a non-ordered phase does not provide ferromagnetism. Thus, in order to form an ordered phase, it is necessary to carry out heat treatment (annealing). In heat treatment, by using Differential Thermal Analysis (DTA), the transformation temperature of the alloy constituting the alloy particles for transformation between ordered to non-ordered is determined. It is necessary that the heat treatment is carried out at a temperature which is at or above this transformation temperature.

The above transformation temperature is usually 500° C., but may be lowered by the addition of a third element. Also, by appropriate changes to the atmosphere of the above oxidation and annealing processes, the transformation temperature can be lowered. Hence it is preferable that the annealing processing temperature is made 150° C. or above, and more preferable that it is made between 150 and 450° C.

Typical examples of magnetic recording media are magnetic recording tapes, and Floppy Disks (trade mark). After forming a magnetic layer on a web-like state of organic support thereof, the former can be processed into tape-like shapes, and the latter can be manufactured by punching out into disc-like shapes. The present invention is effective when organic materials are used for the support, from the perspective of being able to reduce the transformation temperature to the ferromagnetic state, and so it is preferable that the invention is applied to such applications.

For carrying out the annealing processing in the web-like state, it is preferable that the annealing time is short. If the time for annealing is long then a large apparatus is required. For example, if the conveying speed is 50 m/min and the annealing time is 30 minutes then the length of the line will become 1500 m. Here, it is preferable that in the manufacturing method of the magnetic particles of the invention that the annealing processing time is made 10 minutes or less, and 5 minutes or less is more preferable.

In order to reduce the annealing time as above, it is preferable that, as stated above, the atmosphere for carrying out the annealing processing is made a reducing atmosphere. This is effective for preventing distortion of the support, and also effective for preventing the diffusion of impurities from the support.

Also, when annealing processing is carried out in the particle state, then movement of the particles can easily occur, as can fusion. Hence, whilst it is possible to obtain strong coercivity, there is the disadvantage that the particle size increases. Hence, it is preferable to carry out the annealing process in the state of coating on the pattern (the layer of graft-polymer), from the perspective of being able to prevent the aggregation of the alloy particles. Furthermore, by making the magnetic particles by annealing alloy particles on the pattern (the layer of graft-polymer), a magnetic recording medium of a magnetic layer formed from such magnetic particles can be provided.

It is preferable that the magnetic layer coating liquid is coated onto the pattern (the layer of graft-polymer) after carrying out the oxidation process for coating the alloy particles on the pattern (the layer of graft-polymer). It is preferably to include the alloy particles in an amount which is the desired concentration (0.01 to 0.1 mg/ml) at this time.

For the method of coating onto the pattern (the layer of graft-polymer), the following can be used: air doctor coating, blade coating, rod coating, extrusion coating, air-knife coating, squeeze coating, dip coating, reverse roll coating, transfer roller coating, gravure coating, kiss coating, cast coating, spray coating, spin coating and the like. For the atmosphere under which the annealing process is carried out, in order to make the phase transformation progress effectively and prevent oxidation of the alloys, it is preferable that it is a non-oxidizing atmosphere such as H₂, N₂, Ar, He, Ne. In particular, from the perspective of removing oxygen present in the lattice in the oxidation process, a reducing atmosphere, such as methane, ethane, or H₂ is preferable. Furthermore, in order to maintain the particle diameters, it is preferable that the annealing process is carried out in a reducing atmosphere in a magnetic field. Here, with a H₂ atmosphere, in order to prevent explosion, it is preferable that an inert gas is mixed therewith.

Also, in order to prevent the fusion of particles during annealing, it is preferable that, annealing is carried out once at a temperature below the transformation temperature in an inert gas atmosphere, and after carbonizing the dispersing agent, annealing processing is carried out at a temperature above the transformation temperature in a reducing atmosphere. At this time the optimum conditions are when after carrying out the annealing at the temperature below the transformation temperature, a silicon based resin or the like can be coated onto the layer containing the alloy particles, as required, and the annealing at the temperature above the transformation temperature is carried out.

By carrying out the annealing processing above, the alloy particles can be phase-changed from non-ordered phase to ordered phase, and magnetic particles with ferromagnetism can be obtained.

Magnetic particles manufactured in the above way preferably have a coercivity of 95.5 to 398 kA/m (1200 to 5000 Oe). And when used for a magnetic recording medium, considering the compatibility with recording heads, it is preferable that the coercivity is 95.5 to 278.6 kA/m (1200 to 3500 Oe). Also, it is preferable that the size of the magnetic particles is from 1 to 100 nm, more preferably from 3 to 20 nm and most preferably from 3 to 10 nm.

In the present step, the support is preferably polished as the need arises to make the surface smooth.

A polishing slurry used preferably in the polishing may be obtained by dispersing a ceria polishing material or a silica polishing material into a dispersing medium such as water.

The ceria polishing material, which may be used to obtain the polishing slurry used preferably in the invention, is generally commercially available, and may have an average particle diameter of, for example, 0.1 to 5 μm, in particular, 0.2 to 1.5 μm.

The silica polishing material, which may be used to obtain the polishing slurry used preferably in the invention, is generally commercially available as fumed silica, precipitated silica, colloidal silica or the like, and is in particular preferably colloidal silica. Colloidal silica may have an average particle diameter of, for example, 0.01 to 0.2 μm, in particular 0.04 to 0.2 μm.

The dispersing medium, which may be used for the polishing slurry used preferably in the invention, may be water, or an organic solvent such as a water-soluble organic solvent. Water is preferred as the dispersing medium.

The polishing slurry used preferably in the invention may optionally contain a surfactant as a dispersing agent. This surfactant may be an anionic surfactant, a cationic surfactant, a nonionic surfactant, an amphoteric surfactant, or a combination thereof.

The polishing slurry used preferably in the invention is particularly useful for polishing a crystallized glass support having a crystalline phase portion and an amorphous phase portion. This is based on a matter that the ceria polishing material in the polishing slurry exhibits a good polishing effect onto the amorphous phase portion of the crystallized glass support by chemical and mechanical action, and further the silica polishing material in the polishing slurry in the invention exhibits a good polishing effect onto the crystalline phase portion, wherein prompt polishing may not be attained only with the ceria polishing material, by mechanical action. Furthermore, according to the polishing slurry, a good polishing performance may be exhibited by use of the polishing material at a low concentration. Thus, costs of the polishing slurry may be decreased.

When the polishing slurry used preferably in the invention is used to perform support-polishing, upper and lower surface plates each having a surface on which a polishing cloth is stretched are used as a polishing member to sandwich plural supports held by carriers between these surface plates, and then the upper surface plates are rotated, whereby both surfaces of each of the supports may be simultaneously polished. The polishing slurry in the invention may be used in any other polishing method using a brush, a polishing tape, a polishing pad or the like.

The polishing step may be performed at a single stage or at plural separated stages. In the latter case, the polishing step may be composed of a roughly polishing substep of removing a processing denatured layer and injures and controlling the shape of end portions of the medium, and a finally polishing substep of making the medium surface smooth to remove surface defects.

In the roughly polishing substep, a polishing pad made of a relatively hard foamed urethane or the like (i.e., a hard polisher) is used as a polishing member, and in the finally polishing substep, a polishing pad made of a relatively soft artificial leather suede or the like (i.e., a soft polisher) is used as a polishing member. The polishing member combined with the polishing slurry used preferably in the invention in order to polish the medium is not limited in the invention. For example, a urethane pad, a nonwoven cloth pad or an epoxy resin pad may be used as the hard polisher, and a suede pad or a nonwoven cloth pad may be used as the soft polisher.

(Protective Layer)

Also, a protective layer may be formed on the magnetic layer (the magnetic region) on the support to improve the abrasion resistance. Further still, a lubricant may also be applied onto the protective layer to increase the sliding properties so that the resulting magnetic recording medium can have sufficient reliability.

Examples of the material for the protective layer include oxides such as silica, alumina, titania, zirconia, cobalt oxide, and nickel oxide; nitrides such as titanium nitride, silicon nitride and boron nitride; carbides such as silicon carbide, chromium carbide and boron carbide; and carbon such as graphite and amorphous carbon. Preferable are materials containing at least one of C or Si.

Examples of materials which contain at least one of C or Si which can be given are; Si compounds, such as, silica, silicone nitride; carbide compounds such as silicon carbide, chromium carbide, boron carbide; and carbon compounds such as graphite, and amorphous carbon. Particularly preferable is so called diamond-like carbon which is a hard amorphous form of carbon. Also, it is also possible to form structure with a sol-gel film which includes Si or C.

A protective carbon layer made of carbon can have sufficient resistance to abrasion even when very thin, so that seizing-up of a sliding member due to heat does not easily develop. Thus, carbon lends itself particularly well to being a material for the protective layer. A protective carbon layer is generally formed by a sputtering method in the case of a hard disk. A number of methods using a high deposition rate plasma CVD technique are proposed for a product which has to be formed through a continuous film formation, such as a video tape. Thus, any of these methods is preferably used.

Among these, it is reported that a plasma injection CVD (PI-CVD) method can form a film at very high speed and can produce a hard protective carbon film with less pinholes and with good quality (for example, see JP-A Nos. 61-130487, 63-279426 and 03-113824), the disclosures of which are incorporated by reference herein.

The protective carbon film preferably has a Vickers hardness of more than 1000 kg/mm², more preferably of more than 2000 kg/mm². Preferably, it has an amorphous structure and is non-electrically conductive.

When a diamond-like carbon film is used as the protective carbon film, its structure can be determined by Raman spectroscopic analysis. That is, when a diamond-like carbon film is measured, the structure can be confirmed by the detection of a peak at a wave number of 1520 to 1560 cm⁻¹. As the structure of a carbon film deviates from a diamond-like structure, the peak detected by the Raman spectroscopic analysis deviates from the above range, and the hardness of the protective layer also decreases.

Preferred carbon materials for use in forming the protective carbon film include carbon-containing compounds such as: alkanes, such as methane, ethane, propane, and butane; alkenes, such as ethylene and propylene; and alkynes, such as acetylene. A carrier gas such as argon or an additive gas for improving the film quality, such as hydrogen and nitrogen may be added as required.

If the protective carbon film is too thick, the electromagnetic transfer characteristics can be degraded, or its adhesiveness to the magnetic layer can be reduced. If the film is too thin, its abrasion resistance can be insufficient. Thus, the film preferably has a thickness of 2.5 to 20 nm, more preferably of 5 to 10 nm. In order to improve the adhesiveness between the protective layer and the magnetic layer to be a support, it is preferred that the surface of the magnetic layer should be improved in advance by etching with an inert gas or modified by exposure to a reactive gas plasma such as an oxygen plasma.

In order to improve the running durability and the corrosion resistance, a lubricant layer is preferably formed on the protective layer. The lubricant to be added to form the lubricant layer may be a known hydrocarbon lubricant, a known fluoro-lubricant, a known extreme-pressure additive, or the like. The lubricant layer is preferably formed by use of a compound comprising fluorine.

Examples of the hydrocarbon lubricant include: carboxylic acids, such as stearic acid and oleic acid; esters, such as butyl stearate; sulfonic acids, such as octadecyl sulfonic acid; phosphates, such as monooctadecyl phosphate; alcohols, such as stearyl alcohol and oleyl alcohol; carboxylic amides, such as stearic acid amide; and amines, such as stearylamine.

Preferable examples of the fluoro-lubricant include modifications of the above hydrocarbon lubricants in which part or the whole of the alkyl group is substituted with a fluoroalkyl group or a perfluoropolyether group.

The perfluoropolyether group may be a perfluoromethylene oxide polymer, a perfluoroethylene oxide polymer, a perfluoro-n-propylene oxide polymer (CF₂CF₂CF₂O)n, a perfluoroisopropylene oxide polymer (CF(CF₃)CF₂O)n, or any copolymer thereof.

The lubricant layer of the present invention is mainly composed of a fluorine based lubricant, and the thickness of the layer is preferably about 2 to about 20 nm, more preferably about 5 to about 10 nm.

The hydrocarbon lubricant may have a polar functional group such as a hydroxyl group, an ester group or a carboxyl group at the end of the alkyl group or in its molecule. Such a compound is preferred because it can be highly effective in reducing the frictional force.

Its molecular weight may be from 500 to 5000, preferably from 1000 to 3000. If the molecular weight is from 500 to 5000, the volatilization can be suppressed, and a high lubricity can also be maintained. In addition, accidental stopping of the running or head crashing can be prevented by avoiding the adherence of the disk to a slider.

For example, such the perfluoropolyether is commercially available under the trade name of FOMBLIN (trade name, manufactured by Ausimont) or KRYTOX (trade name, manufactured by DuPont). Examples of the extreme-pressure additive include phosphates such as trilauryl phosphate, phosphites such as trilauryl phosphite, thiophosphates and thiophosphites such as trilauryl trithiophosphite, and a sulfur extreme-pressure agent such as dibenzyl disulfide.

The lubricants may be used alone or in combinations. Any of these lubricants may be applied to the protective layer by applying a solution of the lubricant in an organic solvent by a wire-bar coating method, a gravure coating method, a spin coating method, a dip coating method, or the like, or by depositing the lubricant by a vacuum vapor deposition method.

Also, in addition to the lubricant, anti-corrosion agents may be used. Examples of the anti-corrosion agent include: nitrogen-containing heterocyclic compounds, such as benzotriazole, benzimidazole, purine, and pyrimidine, and derivatives thereof in which an alkyl side chain is introduced to the main ring; and nitrogen and sulfur-containing heterocyclic compounds, such as benzothiazole, 2-mercaptobenzothiazole, tetrazaindene cyclic compounds, and thiouracil compounds, and derivatives thereof.

In order to make vertical magnetic recording, a soft magnetic layer is preferably formed between the support and the magnetic layer. The soft magnetic layer may be any known one.

It is preferred to form a layer for promoting vertical orientation of a magnetic body, for example, a layer made of MgO between the soft magnetic layer and the magnetic layer.

In order to use the magnetic recording medium as a high-density recording medium, the surface of the magnetic recording medium is preferably made to have a quite excellent smoothness. The method for obtaining such a surface may be a method of forming the magnetic layer on the support and then subjecting the resultant to calendaring treatment or varnish treatment.

<Magnetic Recording Medium>

The magnetic recording medium of the invention is a magnetic recording medium produced by the above-mentioned magnetic recording medium method of manufacturing the invention. According to the magnetic recording medium of the invention, transition noises may be decreased since the medium is obtained by the magnetic recording medium method of manufacturing the invention.

About the magnetic recording medium of the invention, the centerline average roughness of the surface is preferably from 0.1 to 5 nm, more preferably from 0.25 to 2 nm at a cutoff value of 0.25 mm. It is preferred that the surface of the medium is made to have a quite excellent smoothness in order to use the medium as a magnetic recording medium for high-density recording.

### EXAMPLES

The present invention is specifically explained by way of Examples below, which should not be construed as limiting the invention thereto.

### Example 1

(Preparation of FePt Alloy Particles)

The process as shown below was performed in high purity N₂ gas.

To a reducing agent aqueous solution containing 0.76 g of NaBH₄ (manufactured by Wako Pure Chemical Industries Ltd.) dissolved in 16 ml of water (deoxygenated to 0.1 mg/l or below) was added an alkane solution of a mixture of 10.8 g of Aerosol OT (manufactured by Wako Pure Chemical Industries Ltd.), 80 ml of decane (manufactured by Wako Pure Chemical Industries Ltd.), and 2 ml of oleyl amine, mixed and a reverse micelle solution (I) was thereby prepared.

To a metal salt aqueous solution containing 0.46 g of iron triammonium trioxalate (Fe(NH₃)₃(C₂0₄)₃) (manufactured by Wako Pure Chemical Industries Ltd.), and 0.38 g of potassium platinum chloride (K₂PtCl₄) (manufactured by Wako Pure Chemical Industries Ltd.) dissolved in 12 ml of water (deoxygenated) was added an alkane solution of 5.4 g of Aerosol OT (manufactured by Wako Pure Chemical Industries Ltd.) mixed with 40 ml of decane (manufactured by Wako Pure Chemical Industries Ltd.), and a reverse micelle solution (II) was thereby prepared.

To the reverse micelle solution (I) at 22° C. being high speed stirred in an Omnimixer (manufactured by Yamato Scientific Co. Ltd.) was quickly added the reverse micelle solution (II). After 10 minutes, the temperature was raised to 50° C. while stirring with a magnetic stirrer and was allowed to stand for 60 minutes for aging.

2 ml of Oleic acid (manufactured by Wako Pure Chemical Industries Ltd.) was added to the mixture of the reverse micelle solution (I) and the reverse micelle solution (II), and then the solution was cooled to room temperature. After cooling, the resultant mixture solution was taken out into the atmosphere. In order to breakdown the reverse micelle, a mixture solution of 100 ml of water and 100 ml of methanol was added to separate into water and oil phases. Alloy particles were obtained in a dispersed condition in the oil phase. The oil phase was washed 5 times with a mixed solution of 600 ml of water with 200 ml of methanol.

Then, the alloy particles were flocculated by adding 100 ml of methanol to cause precipitation of the particles. The supernatant liquid was removed, 20 ml of heptane (manufactured by Wako Pure Chemical Industries Ltd.) was added and re-dispersion was carried out. Precipitation with 100 ml of methanol and dispersion with 20 ml of heptane was carried out a further 2 times, and finally 5 ml of heptane was added, and an alloy particle containing liquid which contains FePt alloy particles and a surfactant in which the ratio of water to the surfactant (water/surfactant) of 2 by mass was prepared.

The yield, composition, volume average particle diameter and distribution (variation coefficient) of the resultant alloy particles were measured, and the following results were obtained.

The composition and yield were determined by the measurement by ICP spectroscopic analysis (inductive coupling high frequency plasma spectroscopic analysis). Volume average particle diameter and size distribution were determined by measuring microscopic photographic images of particles taken with a TEM (transmission type electron microscope: Hitachi Ltd.; 300 kV) and processing the measured data statistically. For the measurement of the alloy particles, the alloy particles collected from the prepared alloy particle solution were thoroughly dried, and used after heating the particles in an electric oven.
Composition: FePt alloy with Pt 44.5 at %; Yield: 85%
Average particle diameter: 4.2 nm, Variation coefficient: 5%

(Preparation of an Alloy-Particle-Containing Liquid)

The resultant alloy-particle-containing surfactant solution was subjected to vacuum deairing so as to be concentrated into an alloy-particle concentration of 12% by mass. Thereto was added decane so as to dilute the solution. In this way, a 2% by mass alloy-particle-containing liquid was prepared.

(Microcontact Printing)

1. Formation of a PDMS Stamp

Polydimethylsiloxane (trade name: SYLGARD 184, manufactured by Dow Corning Co.) was cast into a mold of a silicon support wherein a pattern was formed, and the siloxane was heated at 80° C. for 2 hours to be cured. After the curing, the cured product was peeled off from the master, thereby yielding a stamp of polydimethylssiloxane (PDMS) (a PDMS stamp) wherein the pattern of the mold was transcribed.

2. Adhesion of a Polymerization Initiator Onto the PDMS Stamp

As a polymerization initiator, used was a polymerization initiator (P1 described above) of a compound having a carbon-halogen bond and having a chlorosilane bond. A 1% by mass solution of this initiator in toluene was prepared, and then the PDMS stamp was immersed into this solution. The stamp was pulled out from the solution, and then dried in a nitrogen gas flow for 30 seconds. Immediately thereafter, a silicon support (outer diameter: 65 mm, inner diameter: 20 mm, and thickness: 0.635 mm) was pushed thereon, and the resultant was kept as it was for 10 seconds. Next, the stamp was separated away, and the suport on which the polymerization initiator was caused to adhere was heated and dried in an oven at 80° C. for 30 minutes to fix the polymerization initiator into a pattern form on the support (the formation of a polymerization initiating layer).

(Graft Polymerization)

The support on which the polymerization initiating layer was formed was immersed into a 10% by mass solution of acrylic acid in water, and then taken out. Thereafter, a 400-w high-pressure mercury lamp was used to irradiate light to the support in an atmosphere of argon for 15 minutes. After the irradiation of the light, the support was sufficiently washed with ion exchange water to generate a graft polymer wherein acrylic acid was graft-polymerized on the polymerization initiating layer surface. The height (layer thickness) of the pattern (the graft polymer layer) was 13 nm.

The alloy-particle-containing liquid was coated onto the graft polymer layer in the air by spin coating, so as to form an alloy-particle-containing layer.

This was heated at 250° C. in the air to cure the alloy-particle-containing layer and further oxidize the alloy particles in the alloy-particle-containing layer.

Furthermore, in a polishing machine (trade name: MA-200D, manufactured by Musashino Denshi Co.), a polishing slurry (trade name: COMPOL 20, manufactured by Fujimi Inc. was used to polish the support surface.

(Annealing Processing, and So On)

The resultant was heated in an electric furnace (450° C.), the atmosphere inside of the furnace being an H₂ and Ar mixed gas (H₂:Ar=5:95), at a temperature-raising rate of 50° C./minute for 30 minutes, and then the temperature of the system was lowered to room temperature at a rate of 50° C./minute to attain annealing processing, thereby forming a magnetic layer (magnetic regions) made of a ferromagnetic ordered alloy. The layer thickness of the magnetic layer was 20 nm.

Thereafter, a carbon protective layer 5 nm in thickness was formed on the magnetic layer by sputtering. Furthermore, prepared was a solution wherein a sol (trade name: FONBRIN Z SOL manufactured by Ausimont Co.) was diluted with a solvent (trade name: FLORINATE FC72) into a concentration of 1% by mass. Using a dip coater, the workpiece was pulled up from the solution at 10 mm/minute to coat the solution, thereby forming a lubricant layer on the protective layer. In this way, a magnetic recording medium was produced.

### Example 2

A magnetic recording medium was produced in the same way as in Example 1 except that the photopolymerization initiator (P1) was changed to a photopolymerization initiator of an aromatic ketone having a chlorosilane terminal (P2 described above).

### Comparative Example 1

In the method of producing the magnetic recording medium of Example 1, neither polymerization initiating layer nor graft polymer layer was formed on the support to form magnetic regions on the support. Specifically, the following process was performed:

(Formation of Magnetic Regions)

(1) A carbon layer was formed as a matrix layer on the same support as used in the production of the magnetic recording medium of Example 1 by sputtering. The thickness was 50 nm.

(2) Next, SAITOP (trade name; manufactured by Asahi Glass) was coated at a thickness of 100 μm to form a resist film.

(3) The resist film was exposed with ultra-violet light according to a bit pattern to form a patterned mask having a bit pattern array. The bit pattern was a 500 nm by 500 nm pattern with a pattern spacing distance of 100 nm.

(4) A reactive ion etching method for etching selectively the matrix layer uncovered with the patterned mask was used to form, in the matrix layer, the same bit array pattern as formed in the resist mask. The etching was performed at an etching rate of 1 μm/h, using a beam having a diameter of 1 cm. A time of about 40 minutes was required for etching the disk having a diameter of 2.5 inches.

(5) The alloy-particle-containing liquid prepared in the method of producing the magnetic recording medium of Example 1 was coated on the disk in the air by spin coating.

(6) The resultant was heated in the air at 200° C. to cure an alloy-particle-containing layer and further oxidize the alloy particles in the alloy-particle-containing layer.

(7) An appropriate solvent (water containing 20 ppm or more of ozone) was used to dissolve and remove the patterned mask as the resist mask.

(Annealing Processing and the Like)

Annealing processing is carried out by raising the temperature at a rate of 50° C. per minute, in an atmosphere of an H₂ and Ar mixed gas (H₂:Ar=5:95) in an electric oven (450° C.) for 30 minutes, and then reducing the temperature at a rate of 50° C. per minute to room temperature to form the regions of ferromagnetic bodies. The thickness of the film was 50 nm.

Thereafter, a carbon protective layer 5 nm in thickness was formed on the magnetic layer by sputtering. Furthermore, prepared was a solution wherein a sol (trade name: FONBRIN Z SOL manufactured by Ausimont Co.) was diluted with a solvent (trade name: FLORIANTE FC72) into a concentration of 1% by mass. Using a dip coater, the workpiece was pulled up from the solution at 10 mm/minute to coat the solution, thereby forming a lubricant layer on the protective layer. In this way, a magnetic recording medium was produced.

### Comparative Example 2

A magnetic recording medium was produced in the same way as in Comparative Example 1 except that the matrix layer was not formed (so that selective etching of the matrix layer (corresponding to the item (4)) was not performed, either.

(Evaluations)

—Magnetic Property (Measurement of Coercive Force)—

An FIB (trade name: SMI2050, manufactured by Seiko Instruments Inc.) was used to cut each of the magnetic recording media produced in Examples 1 and 2 and Comparative Examples 1 and 2 to give an end face. The end face was observed with a transmission electron microscope (trade name: H9000, manufactured by Hitachi Ltd.) at an accelerating voltage of 300 kV.

The magnetic property (coercive force) of the magnetic layer of each of the magnetic recording media was measured. A magnetizing machine (trade name: MPM-04, manufactured by Toei Industry Co., Ltd.) having a solenoid was used to apply a magnetic field having an intensity of 40 kOe to the medium in the in-plane direction thereof, and then a highly-sensitive magnetization vector measuring device manufactured by Toei Industry Co., Ltd. and a data processing machine manufactured by the same were used to make the measurement at an applied magnetic field intensity of 790 kA/m (10 kOe). About the magnetic recording media of Examples 1 and 2 and Comparative Examples 1 and 2, the coercive forces thereof were each about 3000 Oe. The results are shown in Table 2.

—Productivity—

The productivities (production efficiencies) of Examples 1 and 2 and Comparative Examples 1 and 2 were evaluated by comparing times required to form the patterns before the alloy-particle-containing liquids which contained FePt were coated. Up to the completion of the magnetic recording media, a time of 30 minutes was required in Examples 1 and 2 while a time of about 2 hours was required in Comparative Examples 1 and 2. The results are shown in Table 2.

TABLE 2

| | Magnetic property: coercive | Productivity: |
|---|---|---|
| | force (Oe) | producing time |
| Example 1 | About 3000 | 30 minutes |
| Example 2 | About 3000 | 30 minutes |
| Comparative example 1 | About 3000 | About 2 hours |
| Comparative example 1 | About 3000 | About 2 hours |

It is understood that in Examples 1 and 2 and Comparative Examples 1 and 2, low transition noises were realized since the magnetic regions therein were made independently of each other.

It is also understood that in Examples 1 and 2, the productivity was excellent since the pattern was formed in a time of about ¼ of the time required in Comparative Examples 1 and 2.

According to the invention, there may be provided a magnetic recording medium which causes a reduction of transition noises and has a high productivity.

Accordingly, the invention may provide aspects and exemplary embodiments in the following items <1> to <5>:
<1>. A method of manufacturing a magnetic recording medium, comprising:

fixing a polymerization initiator on a support by microcontact printing,

forming a grafted polymer pattern by bringing a compound having a polymerizable unsaturated bond into contact with the polymerization initiator fixed on the support followed by graft polymerization of the compound, and

forming a magnetic region by coating, onto the pattern, an alloy-particle-containing liquid which contains alloy particles capable of forming a CuAu pattern or Cu₃Au pattern ferromagnetic ordered alloy, and further subjecting the resultant to annealing processing, thereby forming a plurality of magnetic regions physically independent of each other.
<2>. The method of manufacturing item <1> above, further comprising polishing the surface of the support, which has the formed magnetic regions thereon.
<3>. The method of manufacturing item <1> or <2> above, further comprising an oxidizing treatment.
<4>. The method of manufacturing any one of items <1> to <3> above, further comprising forming a protective layer.
<5>. A magnetic recording medium produced by the method of manufacturing any one of items <1> to <4> above.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. The scope of the invention, therefore, should be determined by the following claims.

What is claimed is:

1. A method of manufacturing a magnetic recording medium, comprising:
fixing a polymerization initiator on a support by microcontact printing,
forming a grafted polymer pattern by bringing a compound having a polymerizable unsaturated bond into contact with the polymerization initiator fixed on the support followed by graft polymerization of the compound, and
forming a magnetic region by coating, onto the pattern, an alloy-particle-containing liquid which contains alloy particles capable of forming a CuAu pattern or Cu₃Au pattern ferromagnetic ordered alloy, and further subjecting the resultant to annealing processing, thereby forming a plurality of magnetic regions physically independent of each other.

2. The method of claim 1, further comprising polishing the surface of the support, which has the formed magnetic regions thereon.

3. The method of claim 1, further comprising oxidizing treatment.

4. The method of claim 2, further comprising oxidizing treatment

5. The method of claim 1, further comprising forming a protective layer.

6. The method of claim 3, further comprising a protective layer forming step.

7. The method of claim 4, further comprising a protective layer forming step.

8. A magnetic recording medium produced by the method of claim 1.

9. A magnetic recording medium produced by the method of claim 3.

10. A magnetic recording medium produced by the method of claim 7.
